(19) United States
(12) Patent Application Publication
(10) Pub. No.: US 2026/0073013 A1
(43) Pub. Date: Mar. 12, 2026

(54) PERSISTING AND RESTORING IN-MEMORY NEIGHBOR GRAPH VECTOR INDEXES

(71) Applicant: Oracle International Corporation, Redwood Shores, CA (US)

(72) Inventors: Agnivo Saha, Belmont, CA (US); Aurosish Mishra, Sunnyvale, CA (US); Martin Brugnara, Zurich (CH); Hao Zhou, Solon, OH (US); Vlad Ioan Haprian, Zurich (CH); Laurent Phillipe Daynes, Saint-Ismier (FR); Shasank Kisan Chavan, Menlo Park, CA (US)

(21) Appl. No.: 19/063,025

(22) Filed: Feb. 25, 2025

Related U.S. Application Data
(60) Provisional application No. 63/692,497, filed on Sep. 9, 2024.

(51) Int. Cl. G06F 17/16

(52) U.S. Cl. CPC G06F 17/16

(57) ABSTRACT

Techniques persist and restore in-memory neighbor graph vector indexes that include a vertex identifier to vector mapping and include a neighbor graph of vector neighbor vertices. At least one neighbor graph vector index checkpoint factor can be identified. A determination can be made as to whether to generate a full neighbor graph vector index checkpoint or an incremental neighbor graph vector index checkpoint based on the checkpoint factor.

### CROSS-REFERENCE TO RELATED APPLICATIONS

This application is related to U.S. patent application Ser. No. 18/885,640, filed on Sep. 14, 2024, and an application titled “PERSISTING AND RESTORING IN-MEMORY NEIGHBOR GRAPH VECTOR INDEXES,” Attorney Docket No. 50277-6437, filed on the same day as the present application, the entire contents of which are hereby incorporated by reference.

### BENEFIT CLAIM

This application claims the benefit of provisional application 63/692,497, filed Sep. 9, 2024, the entire contents of which are hereby incorporated by reference.

### FIELD

The present disclosure relates generally to vector indexes and, more particularly, to techniques for persisting and restoring in-memory neighbor graph vector indexes.

### BACKGROUND

A vector is a fixed-length sequence of numbers, typically floating point numbers, such as [21.4, 45.2, 675.34, 19.4, 83.24], which is a five-dimensional vector. An embedding is a means of representing objects (e.g., text, images, and audio) as points in a continuous vector space where the locations of those points in space are semantically meaningful to one or more machine learning (ML) algorithms. An embedding is often represented as a vector. Generically, a vector embedding represents a point in N-dimensional space. Vector embeddings are intended to capture the important “features” of the data that the vector embeddings represent (or embed). The data a vector embedding represents can be one of many types of data, such as a document, an email, an image, or a video. Examples of features are color, size, category, location, texture, meaning, and concept. Each feature is represented by one or more numbers (dimensions) in the vector embedding. Hereinafter, a “vector embedding” is referred to as a “vector.”

Today, vectors are often generated by machine-learned models (e.g., neural networks) and the features they represent are often difficult for humans to understand. One way that vectors are produced by neural networks is by capturing the outputs of the neurons in the penultimate layer, i.e., the neural network's outputs just before the final processing layer.

### Distance Between Vectors

An important attribute of vectors is that the distance between two vectors is a good proxy for the similarity of the objects represented by the vectors. Two vectors that represent similar data should be a short distance from each other in vector space. The opposite is also true: dissimilar data are represented by vectors that are far apart from each other in the vector space. For example, the distance between a vector for the word “cat” and a vector for the word “dog” should be less than the distance between the vector for the word “cat” and a vector for the word “plant.”

The distance between two vectors is often calculated by summing the squares of the difference between the numbers in each position of the vectors:

$$( Vector 1 [ 1 ] - V e c tor 2 [ 1 ] ) \hat{} 2 + ( Vector 1 [ 2 ] - V e c t o r 2 [ 2 ] ) \hat{} 2 + …$$

The property that vector distance represents object similarity is what allows similar data to be found using a vector database. For example, when a vector representing a picture of a dog is searched for in a vector database, the nearest vectors will be those representing other dogs, not vectors representing plants.

### Vector Processing Workloads

Vector processing workloads (not to be confused with single instruction, multiple data (SIMD) vector processing) have been used in Natural Language Processing (NLP), image recognition, recommendations, etc. Vector processing workloads have two sub-categories that require separate optimization strategies: indexing and searching. Regarding indexing, vector embeddings (or simply vectors) are indexed using approximate indexing techniques. Unlike B-tree indexes, a vector index returns many matching values ranked by similarity. Index creation and rebuild tend to be Central Processing Unit (CPU) intensive and are optimized for throughput.

Regarding searching, the stored vectors are searched using a class of algorithms known as “Similarity Search” or “Approximate Nearest Neighbor (ANN)” to find the closest vectors to a query vector. A search is designed to minimize CPU usage in order to minimize response time.

### Vector Processing Patterns

A vector similarity search is like interactive online transaction processing (OLTP) in that end-users submit vector queries and expect an instant reply. Vector similarity search requires millisecond response times to find vectors that are close (represent similar data) even when the database in which the vectors are stored holds billions of vectors. An example query is “find products that are similar to this picture [reference to a digital image].” Another example query is “find corporate documents that conceptually match this natural language prompt: [NL prompt].”

Providing fast response times requires using specialized vector indexes and fast algorithms for computing distances between vectors. In some use cases, there is a need to combine vector similarity search with relational data. For example, a query may ask for data about houses that match a natural language prompt, are valued at over $1M, are in zip code 94070, and whose owner recently declared bankruptcy. Also, there may be a need to be able to insert new vectors into a database, delete vectors from the database, and index the vectors in real time.

### Vector Databases

Early vector workloads often used flat files or object stores to store vectors. An application would read the vectors out of their backend repositories into memory and perform vector processing using third-party libraries, such as Facebook® artificial intelligence (AI) similarity search (FAISS). Generative AI has greatly increased the volume and processing needs for vectors. Generative AI requires support for much higher volume ingest and faster filtering and retrieval. A database with vector capabilities and built-in indexing is important for these applications.

### Hierarchical Navigable Small Worlds Elements

An in-memory neighbor graph vector index of the type Hierarchical Navigable Small Worlds (HNSW) includes various elements. An HNSW index can also be referred to as an HNSW index. One HNSW index element is an in-memory vector vertex map that tracks all the vectors that are indexed, as well as the row identifiers (IDs) in a base table corresponding to those vectors.

Another HNSW index element is a layer-wise in-memory graph that keeps track of the neighborhood for all vertices. Each layer has a layer vertex ID to neighbor map that maps a vector in a particular layer, Layer (i), to all its neighbor vertices in Layer (i), where “i” identifies the particular layer. Every layer potentially has different vertex IDs. Each layer also has a layer-to-layer vertex ID map that maps a vector's vertex ID from Layer (i) to the vertex ID at Layer (i−1). For example, only some vertices may be nominated to go to a higher layer, and the layer-to-layer vertex ID map maps the vertices in a given layer to the lower layer map for fast navigation. Each layer further has a layer vertex ID to a global vector ID pointer map that maps a local vertex ID to the ID of the vector that is present in the global vector storage.

Another HNSW element is a row ID to vertex ID (also described as VID) map, which is a table that tracks a mapping between physical row IDs for the base table vectors and the logical vertex IDs in the HNSW index. The row ID to VID mapping can improve pre-filtering performance.

Another element is a deleted vectors list that tracks the set of vertices that have been deleted from the base table but still have a presence in the HNSW index. The deleted vectors list can be a bitmap, can be a table, or can be otherwise stored in memory.

### Hnsw Index Creation

An algorithm for an offline HNSW index creation includes computing the number of layers for the index and allocating in-memory space for the index based on the number of vectors in the index. The algorithm includes fetching the (rowID, vector) tuple from the base table and copying it into the in-memory vector storage. The algorithm also includes assigning vertex IDs to the base table vectors and populating the row ID to VID mapping. The algorithm further includes creating HNSW index edges by following an HNSW insertion algorithm. The HNSW index edges represent connections between vectors.

### Hnsw Index Reload

A database instance is a copy of a Database Management System (DBMS) that manages and interacts with the data in a database. Instances may be shut down and restarted for various reasons. One reason is to apply an upgrade patch. Restarting an instance that has an HNSW index requires recreating, such as reloading, the HNSW index. The processing cost of the HNSW index (re)creation is heavily dominated by the vector distance computation during the neighborhood selection for a given vector. After an instance restarts from a shutdown, the in-memory HNSW index reload process has to recreate the graph from scratch, which can take a significant amount of time. This causes bad query performance until the graph has been fully recreated.

### Hnsw Index Duplication

HNSW indexes can be duplicated across nodes of a cluster, such as a Real Application Cluster (RAC). One approach to achieve duplication of the HNSW index is for a primary node in a cluster, such as a primary database instance running on the node, to send a broadcast to all available nodes after the primary node has persisted the row ID to VID mapping. In a decentralized HNSW index creation process, each follower node can build its own HNSW index in parallel, and the index can be opened to queries and Data Manipulation Language (DML) statements once all nodes have duplicated the HNSW index.

Unfortunately, this approach consumes processor (CPU) usage on each instance of the cluster, which makes the duplication process expensive. Further, because each instance builds its own neighborhood HNSW indexes independently, it is possible that the HNSW index connections are different on each node. Due to the approximate nature of the indexes, this means that a Top K similarity search result from Instance 1 may be different from a Top K similarity search result from Instance 2. This is unacceptable for several customers, such as customers in the financial/banking/payments sectors, where the Top K results should not depend on which node the query was served from.

The approaches described in this section are approaches that could be pursued, but not necessarily approaches that have been previously conceived or pursued. Therefore, unless otherwise indicated, it should not be assumed that any of the approaches described in this section qualify as background merely by virtue of their inclusion in this section. Further, it should not be assumed that any of the approaches described in this section are well-understood, routine, or conventional merely by virtue of their inclusion in this section.

### BRIEF DESCRIPTION OF THE DRAWINGS

In order to describe the manner in which advantages and features of the disclosure can be obtained, a description of the disclosure is rendered by reference to specific embodiments thereof which are illustrated in the appended drawings. These drawings depict only example embodiments of the disclosure and are not therefore to be considered to be limiting of its scope. The drawings may have been simplified for clarity and are not necessarily drawn to scale.

FIG. 1 is a block diagram that depicts an example vector database management system (VDBMS) according to an example embodiment.

FIG. 2 is a diagram that depicts an example logical representation of an HNSW index that comprises four layers according to an example embodiment.

FIG. 3 is a block diagram that depicts an example storage architecture for storing an HNSW index according to an example embodiment.

FIG. 4 is a block diagram that depicts the organization of an HNSW index according to an example embodiment.

FIG. 5 is a block diagram that depicts an updated version of an HNSW index after multiple inserts have been made into that index according to an example embodiment.

FIG. 6 is an illustration of a Layer (i) vertex ID to Layer (i−1) vertex ID map checkpoint format according to an example embodiment.

FIG. 7 is an illustration of a Layer (i) vertex ID to neighbor map checkpoint format according to an example embodiment.

FIG. 8 is an illustration of a deleted vectors list checkpoint format according to an example embodiment.

FIG. 9 is an example illustration of a delta Layer (i) vertex ID to Layer (i−1) vertex ID map checkpoint format according to an example embodiment.

FIG. 10 is an example illustration of a delta Layer (i) vertex ID to neighbor map checkpoint format according to an example embodiment.

FIG. 11 is an example illustration of a delta deleted vectors list checkpoint format according to an example embodiment.

FIG. 12 is an illustration of snapshots and segments according to an example embodiment.

FIG. 13 is an illustration of a copy on write process according to an example embodiment.

FIG. 14 is an illustration of a copy on write process while creating snapshots according to an example embodiment.

FIGS. 15 and 16 are example illustrations of index creation without using checkpoints according to an example embodiment.

FIGS. 17 and 18 are example illustrations of index creation using checkpoints according to an example embodiment.

FIG. 19 is a flowchart of a method for checkpoint lower layer units for a neighbor graph vector index according to an example embodiment.

FIG. 20 is a flowchart of a method for checkpoint policies for a neighbor graph vector index according to an example embodiment.

FIG. 21 is a block diagram that illustrates a computer system upon which aspects of the illustrative embodiments may be implemented.

FIG. 22 is a block diagram of a basic software system that may be employed for controlling the operation of computer system.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Embodiments provide techniques to persist and restore in-memory neighbor graph vector indexes that include a vertex identifier to vector mapping and include a neighbor graph of vector neighbor vertices. In a possible embodiment, at least one neighbor graph vector index checkpoint factor can be identified. A determination can be made as to whether to generate a full neighbor graph vector index checkpoint or an incremental neighbor graph vector index checkpoint based on the checkpoint factor. In another possible embodiment, the checkpoint can include a plurality of unit entries. Each unit entry can include vertex data that identifies vertices in respective subsets of a plurality of subsets of vertices in a lower layer of the neighbor graph vector index. Elaboration on the overviews of various embodiments is provided below.

### Disk Checkpoints

Embodiments provide for the creation of a disk checkpoint for an HNSW index. Creating the disk checkpoint enables an HNSW index reload algorithm to load neighbor graphs from the checkpoint instead of creating the HNSW index from scratch. This accelerates the reload significantly as the distance computation during the neighbor selection phase is not needed anymore.

For example, when an instance with an HNSW index is shut down and restarted, the HNSW index is recreated. The main cost of HNSW index creation is the vector distance computation. If the distance computation is avoided by remembering the edges and the neighborhoods, then reload performance is improved. As an example, for one million 4 kB vectors, there can be a 10× (ten times) improvement in restart time because the HNSW index is reloaded as-is, such as by reading a Binary Large Object (BLOB) from a table, and distance computation is no longer necessary. This improves database operation by decreasing the time and expense of bringing the HNSW index back online, which improves the speed of database queries.

### Checkpoint Copies

Embodiments provide for the creation of an HNSW index on a single instance, checkpointing it, and restoring the checkpointed copy on other instances. The use of an HNSW index checkpoint from a single instance ensures that the same HNSW index is duplicated across all instances. For example, in a centralized creation approach, a primary node persists its own HNSW index. Secondary nodes can load the HNSW index into their memories by reading the HNSW index from a checkpoint at the primary node. Thus, checkpointing can be used for multiple node duplication. The use of a common HNSW index checkpoint ensures consistent HNSW indexes across all nodes, which results in consistent query results. Node duplication of the index using a checkpoint also reduces CPU usage by avoiding full index creation from scratch on every instance.

### Checkpoint Unit Entries

At least some embodiments provide for neighbor graph vector index checkpoint unit entries, where a neighbor graph vector index is an HNSW index. For example, the neighbor graph vector index is generated. The neighbor graph vector index includes an index of vertex identifiers between layers of a plurality of layers for a graph-based approximate nearest neighbor search in a vector database. Each layer can have a unique set of edges. The plurality of layers include a higher layer and a lower layer that includes more vertices than the higher layer. A checkpoint is generated based on the neighbor graph vector index. The checkpoint includes a plurality of unit entries. Generating the checkpoint includes identifying a plurality of subsets of vertices in the lower layer. Generating the checkpoint also includes, for each subset in the plurality of subsets: identifying, in the checkpoint, a unit entry that does not include any vertex data; and storing, in the unit entry, vertex data that identifies the vertices in said each subset.

For example, a checkpoint includes serialized data for each layer of an HNSW index. Because the bottom and lower layers can be very large, the serialized data can be broken down into various units, such as multiple BLOBs. This supports parallel serialization and deserialization, such as for loading multiple BLOBs in parallel, which improves processing and data transfer efficiency in a database system.

### Checkpoint Generation Policies

At least some embodiments provide policies for generating checkpoints. In an example embodiment, a neighbor graph vector index is stored. The neighbor graph vector index includes (1) a vertex ID-vector mapping and (2) a neighbor graph of neighbor vertices for a graph-based approximate nearest neighbor search in a vector database. Each edge in the neighbor graph connects two vertices in a layer of the neighbor graph vector index. One or more checkpoint factors are identified. Based on the one or more checkpoint factors, a determination is made as to whether to generate a full checkpoint or an incremental checkpoint of the neighbor graph vector index. The full checkpoint identifies all vertices in the neighbor graph of the neighbor graph vector index at a particular checkpoint time. The incremental checkpoint includes modifications to the neighbor graph vector index at the particular checkpoint time. The modifications to the neighbor graph vector index are modifications that occurred since a previous checkpoint time that is previous to the particular checkpoint time.

The policies provide for the type of checkpoint to take, such as full or incremental, as well as the frequency of checkpoint creation based on a frequency of refreshing the HNSW index. The checkpoint policies result in lower CPU utilization as well as a faster index reload times.

### Checkpoint Schema Definitions

Embodiments further provide schema definitions for the HNSW disk checkpoints. A global table tracks checkpoints for different HNSW indexes. A per-index table stores all the disk checkpoints for a particular index. The schema definitions ensures faster checkpoint creation and faster reloading of an HNSW index using checkpoints. Lower layers, such as the bottom layer, Layer 0, can be broken down into multiple units, which enables processing different units in parallel during checkpoint creation, as well as during reload of the HNSW index using a checkpoint.

### Checkpoint Formats

Embodiments also provide checkpoint formats where the space overhead due to the checkpoint can be minimized. The checkpoint format can mimic the in-memory storage to ensure fast reload times. The formats can include full and incremental checkpoint formats. A serialized format for a full checkpoint can include layer vertex ID-to-lower layer vertex ID maps for each layer, layer vertex ID-to-neighbor maps for each layer, and a deleted vectors list.

Incremental HNSW index checkpoints are made after a full checkpoint. Incremental checkpoints may only track the vertices that underwent changes. A serialized format for an incremental checkpoint can include a delta layer vertex ID-to-lower layer vertex ID map for each layer that underwent changes, a delta layer vertex ID to neighbor map for each layer that underwent changes, and a delta deleted vectors list, where delta indicates only the vectors or segments that have changed are included in the incremental checkpoint.

### Checkpoint Purge Heuristics

Embodiments also provide heuristics to purge checkpoints. The heuristics can be based on the freshness of the latest checkpoints. The heuristics can also be based on user requirements or can be Database Administrator (DBA) command-driven.

Though the term “disk checkpoint” is used, a checkpointed copy can be stored on flash media, non-volatile media (NVM), or any other persistent storage medium. For example, a checkpoint may be stored on a flash cache or Exadata Remote Direct Memory Access (XRMEM) memory on other nodes, such as accelerator nodes.

### Vector Database System Overview

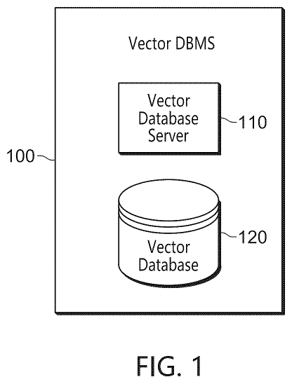

FIG. 1 is a block diagram that depicts an example VDBMS 100 according to an example embodiment. VDBMS 100 includes a vector database server 110 and a vector database 120. The vector database server 110 is communicatively coupled to the vector database 120. VDBMS 100 may be deployed in a network of an enterprise or may be deployed in a cloud environment and, therefore, may be accessible to an enterprise over one or more computer networks (e.g., the Internet). VDBMS 100 may be provisioned for an enterprise by a cloud management team of a cloud provider as needed on an enterprise-by-enterprise basis.

Vector database server 110 includes one or more computing machines, each executing one or more compute instances that receive and process data requests, including data retrieval requests (e.g., queries) and data modification requests (i.e., for vector data modifications), such as inserting vectors, deleting vectors, and updating vectors. A computing instance translates a data request into a storage layer request that the computing instance transmits to vector database 120. A computing machine that hosts at least one compute instance includes (1) one or more processors, (2) volatile memory for storing data requests (and their respective contents) and vector data that is retrieved from vector database 120, and (3) optionally, non-volatile memory.

Vector database 120 may comprise multiple storage devices, each storing vector data and, optionally, one or more non-vector data. For example, vector database 120 stores a table that includes a column for storing vectors and one or more columns for storing user data, such as a column for storing a user identifier, a column for storing a user profile, a column for storing user search history, a column for storing user access history, a column for storing user-generated content, etc. In this example, each row in the table corresponds to a user, such as a customer, a subscriber to a service, etc.

Vector database 120 may also store one or more indexes that index content in vector database 120, such as content stored in one or more base tables. Some of the indexed content may be vector-related data (e.g., actual vector embeddings and metadata thereof) and some of the indexed content may be non-vector-related data, such as content in columns that do not store vectors. Thus, at least one index that vector database 120 may store is a vector index, described in more detail herein.

### Vector Queries

A “vector query” is a query that targets one or more vectors in a vector database, such as vector database 120. Vector database server 110 receives a vector query, generates an execution plan for the vector query, and processes the execution plan in order to retrieve one or more vectors from vector database 120. A vector query typically includes a “query vector” and, optionally, one or more other search criteria. A query vector is a vector that vector database server 110 uses to identify one or more vectors in vector database 120. Examples of one or more other search criteria include dates, numbers, strings, etc. For example, a vector query may ask for the top five matching vectors that are associated with the state of California and a date range between Feb. 1, 2024 and Mar. 5, 2024. Such other search criteria may comprise data from columns that are part of the same table that includes the vector column that stores the vectors that the vector query targets.

In order to identify vectors that are similar to a query vector, vector database server 110 may compare the query vector to each vector stored in vector database 120. However, comparing a query vector to each vector in vector database 120 may take a significant amount of time and users are not willing to wait in order to receive an answer. Also, performing such a naïve scan of vector database 120 given a query vector may require a significant amount of computer resources that could be used for other tasks. To address these problems, a vector index may be generated and used in query vector processing.

### Vector Indexes

Currently, similarity searches are often performed on data sets with billions of vectors (i.e., vector embeddings). For example, the Deep1B dataset contains 1 billion images generated by a Convolutional Neural Network (CNN). Computing VECTOR_DISTANCE with every vector in the corpus to find Top-K matches at 100% accuracy is very slow. As a result, approximate vector indexes are used to trade off search quality (recall/accuracy) for search speed.

Vector indexes tend to group data based on vector similarity with the search restricted to a few groups, achieving significant data pruning. Vector similarity is defined in terms of vector_distanceo calculations. A goal is for a vector index to fit in memory (as opposed to only in slower, long-term (e.g., non-volatile) storage, such as disk) to allow for fast traversals and scans. With modern techniques and memory capacities, an index for billions of vectors can fit into volatile memory. Memory in modern computing machines is large enough for all but the largest workloads of giant web companies.

Two types of vector indexes that may be used to index vectors include HNSW and IVF. HNSW is an in-memory graph that is fast and relatively accurate, but it is larger in size than IVF. IVF is slower and less accurate, but it is smaller in size. Product Quantization (PQ) is a lossy compression technique that may be used to reduce the size of a vector index so that the index may fit into memory or be scanned faster. However, a tradeoff of PQ is lower accuracy. HNSW and IVF may be combined (with or without PQ) to optimize both speed and size.

### Vector Index: Ivf

An IVF index is based on K-means clustering or partitioning. A K-means clustering algorithm is applied to a set of vectors to generate K partitions. The value of K (or the number of partitions) may be based on the number of vectors. For example, K=sqrt(N), where N is the number of vectors. Each partition is identified by a centroid, which is a value that is conceptually the average of the vectors that are assigned to that partition. The centroid of a partition may be considered the “center of gravity” of the partition. A goal in determining a centroid is to minimize the total distance between vectors within a partition and their centroid, so that each centroid is a good representative value for its partition.

An IVF index includes two types of tables: (1) a centroid table that stores all the centroids of all the partitions; and (2) K partition tables, each of which stores the vectors that are assigned to that corresponding partition based on closeness to the centroid represented by the partition. In a similarity search, given query vector, the centroid table is searched first (referred to as the “first-level search”) to identify one or more centroids that are the most similar to (or have the lowest distance to) query vector. Thus, either only a single centroid is selected from the centroid table or multiple centroids are selected from the centroid table. The number of centroids to select may be a default value (e.g., two) and/or may be based on vector distance from the query vector. (For example, select the closest three centroids that are within D vector distance from the query vector). Then, for each selected centroid, the partition to which that identified centroid belongs is searched to identify one or more vectors. This search is referred to as a “second-level search.” If the query vector is for the Top K, then the Top K vectors in each identified partition are identified and then the Top K from the Top K of each identified partition are selected.

### Vector Index: Hnsw

An HNSW index is a multi-layer in-memory graph index that has relatively high speed and accuracy relative to IVF and other vector indexes. The graph index comprises vertices, each vertex corresponding to a vector. The lowest layer of the graph contains vertices of all of the vectors in the indexed data set. Higher layers of the HNSW index have a decaying fraction of the vertices in the layer below. In each layer, vertices are connected to their approximate M closest neighbors using edges that are used to walk the graph. At the lowest layer (“layer 0”), the number of neighbors of each vertex may be different than the number of neighbors of each vertex at higher layers, such as 2M. The vertices at higher layers are on average much farther from each other (relative to lower layers) and, therefore, allow traversal of long distances.

Two major parameters for HNSW index construction are M and R. “M” is referred to as the “neighbor count” and is the number of neighbors that each vertex is connected to on each layer. Layer 0 (the lowest layer) may have double that number (e.g., 2M neighbors). A probability distribution function may be defined based on M in order to determine whether a vertex is to be inserted in a layer that is above the lowest layer. The probability distribution function is such that probabilities decay with higher layers. When the probability drops below 1e-9, then no more layers are added. An example probability distribution function is

$$p ( Layer ) = ( 1 - 1 / M ) / M \hat{} layer$$

Regarding parameter R, when a new vertex (corresponding to a new vector) is inserted into an HNSW index, a random number R between [0.0, 1.0] is generated. A new vertex is always inserted into layer 0. A new vertex is inserted into higher layers up to layer “i” if:

$$R > p ( i - 1 ) + p ( i - 2 ) … + p ( 0 )$$

In an example, with M=10, if R=0.991, then the new vertex is inserted in layers 0 and 1.

An HNSW parameter that is used only for construction is referred to as “efConstruction” and refers to the number of vertices to consider within a layer when looking for the closest M vertices (or closest 2M vertices in layer 0) to which to connect a new vertex. Larger values for this parameter improve index quality but slow down construction. An example value for this parameter is 2M (or 4M for layer 0).

An HNSW parameter that is used in searching is referred to as “efSearch” and refers to the number of vertices to remember in each layer when searching for the K nearest neighbors in a top-K search. Larger values of this parameter improve search quality but slow down searches. An example value for this parameter is 2*K (or double the number of desired K matches).

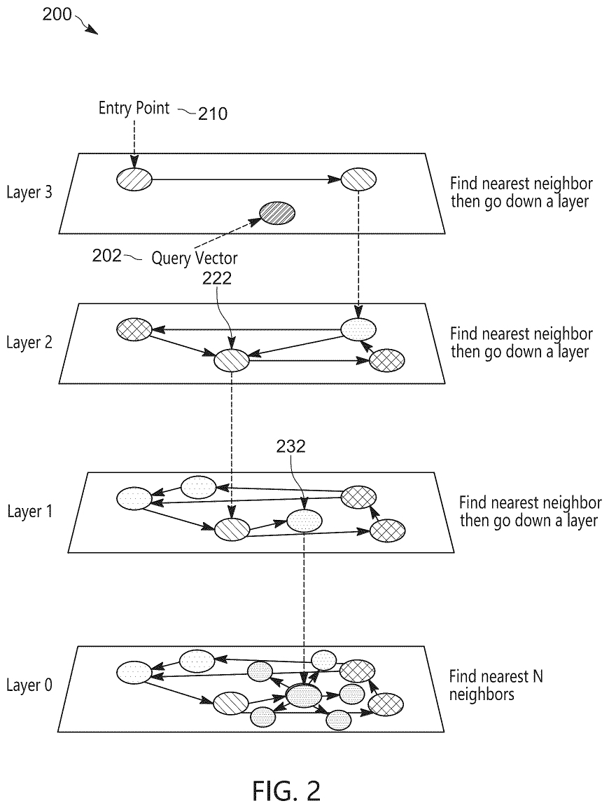

FIG. 2 is a diagram that depicts an example logical representation of an HNSW index 200 that comprises four layers according to an example embodiment. An index search begins from an entry vertex 210 in the top layer (layer 3) and traverses edges looking for the vertex, in that layer, whose vector is nearest query vector 202. If M is 32, then 33 distance calculations are performed between query vector 202 and (i) the vertex of entry vector 210 and (ii) 32 neighbors of entry vector 210. The search process does not only consider neighbors of the entry vector 210, the search process finds the closest neighbor and computes distances for its neighbors as well. This process continues until all the neighbors of a vertex are further from the query vector than the vertex that was used to arrive in that neighborhood. Once the closest vector to query vector 202 in a layer is found (i.e., vertex 212 in this example), the search continues starting with that vertex in the next layer down. This process repeats for each intermediate layer of HNSW index 200. (Thus, vertex 222 is selected in layer 2 and vertex 232 is selected in layer 1.) The index search completes in the lowest layer (i.e., layer 0) by considering the (e.g., 2M) neighbors of vertex 232, in the lowest layer, whose vectors are closest to query vector 202.

For traversing the lowest layer, two heaps are maintained: a candidates heap and a Top K heap. The candidates heap stores vertices that are candidates for further exploration and are ordered based on the distance to the query vector. The Top K heap stores the current best Top K result set so far. The Top K heap holds efSearch vertices. The search proceeds as follows. Vertex 232 is at the top of the candidates heap and all its 2M neighbors are below it in the candidates heap, ordered by distance to query vector 202. Vertex 232 is selected and compared against all vertices in the Top K heap (which is initially empty). The goal is to check whether a vertex popped from the candidates heap can beat the worst vertex (in terms of distance to the query vector) from the Top K heap (which is also a priority queue ordered in reverse, i.e. furthest vertex among the efSearch vertices is at the top of the Top K heap). If the best candidate vertex beats the worst vertex from the current Top K heap, then the best candidate vertex is added to the to the Top K heap and the worst vertex is removed from the Top K heap. The search continues, meaning more candidates are explored. When vertex 232 is selected, the Top K heap is empty, so vertex 232 is automatically added to the Top K heap.

In a scenario where the Top K heap is full (i.e., it contains efSearch vertices), when a vertex V is selected from the candidates heap, the worst vertex in the Top K heap is replaced by V if V beats that worst vertex. All neighbors of V are then added to candidates heap and ordered within the candidates heap, and the next best vertex in the candidates heap is selected and the search continues. The search terminates if the current best candidate in the candidates heap cannot beat the worst vertex in the Top K heap. Increasing efSearch gives accuracy because it is more likely for a candidate vertex to be better than the worst vertex in a set of one hundred vertices in the Top K heap than for the candidate vertex to be better than the worst vertex in a set of ten vertices. Thus, with larger values of efSearch, the exploration goes on longer.

### Vector Index: Hnsw Sizing

HNSW is good to use (compared to IVF) if the HNSW index fits in the memory of one server or computing device. The size of an HNSW index is dominated by layer 0 (higher layers decline rapidly.) Layer 0 includes a vertex for each indexed vector and two vector identifiers (referred to herein as “VIDs”) for each edge connecting two vertices. Each VID may comprise four bytes.

For N vectors of size S with M neighbors each, the index size may be computed as follows:

$$Index Size = Total Size of Vectors + Total Size of Edge Metadata = N * ( S + M * 8 )$$

The following table shows sample index sizes for an HNSW index that is based on one hundred million vectors.

| # of Dimensions | # of Neighbors | Index Size (GB) |
|---|---|---|
| 512 | 16 | 203 |
| 512 | 32 | 215 |
| 512 | 64 | 239 |
| 1024 | 16 | 394 |
| 1024 | 32 | 406 |
| 1024 | 64 | 430 |
| 2048 | 16 | 775 |
| 2048 | 32 | 787 |
| 2048 | 64 | 811 |

Thus, for a server with two terabytes of memory, the maximum number of vectors the server can store are approximately one billion vectors (of 512 dimensions each, each vector with 32 neighbors), five hundred million vectors (of 1024 dimensions each, each vector with 32 neighbors), and two hundred and fifty million vectors (of 2048 dimensions each, each vector with 32 neighbors).

### Hnsw: Example Storage Architecture

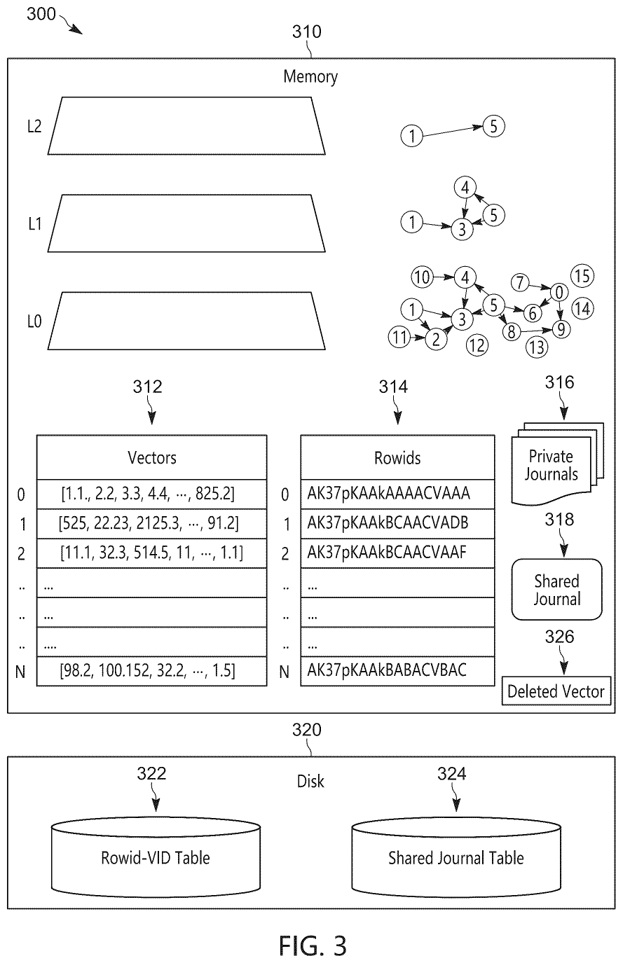

FIG. 3 is a block diagram that depicts an example storage architecture 300 for storing an HNSW index according to an example embodiment. Storage architecture 300 includes memory storage 310 and disk storage 320. Memory storage 310 is part of vector database server 110 and may be on a single compute instance or may represent the memory of multiple compute instances. Similarly, disk storage 320 is part of vector database server 110 and may be part of a single compute instance or may represent persistent storage of multiple compute instances.

Memory storage 310 stores layers 0-2 of an HNSW index along with a vertex vector map 312 (which is different than the base table), rowID table 314, private journals 316, shared journal cache 318, and a deleted vectors list 326. Vertex vector map 312 comprises multiple rows, each row containing a vector and each row being associated with an index value that uniquely identifies a position within vertex vector map 312. Rowid table 314 comprises multiple rows, each row containing a row identifier and each row being associated with an index value that uniquely identifies a position within rowID table 314. The index position is the VID.

Multiple private journals 316 indicate that there are multiple pending transactions that have not yet committed, each private journal corresponding to a different pending transaction. Private journals 316 store data about vector modifications that are initiated by DML statements, such as inserts, deletes, and updates. Each of the private journals 316 exists as long as a vector modification has not yet committed. At commit, one or more changes initiated by a DML statement are stored in shared journal table 324 in disk storage 320 (and, optionally, in shared journal cache 318) Periodically, or in response to certain events occurring or one or more criteria being satisfied, the contents of shared journal table 324 are applied to the HNSW index and vertex vector map 312. Thus, shared journal table 324 allows changes to the HNSW index to be buffered and to be applied to the HNSW index at a later time. Shared journal table 324 may also be used to allow “as of” vector queries, which is a vector query that asks for the state of the vector data “as of” a particular point in time in the past, but after the build/creation time of the HNSW index.

Shared journal cache 318 (1) enables transactionally consistent queries involving vector search, (2) allows for delayed maintenance of the HNSW index, and (3) provides persistence for unapplied changes to the HNSW index, which enables faster restart after a compute instance crashes. Regarding (1), the HNSW index and the shared journal cache 318 (and private journals 316 for in-transaction queries) always contain the changes to the set of indexed vectors since the creation of the HNSW index. Regarding (2), the HNSW index is best maintained in large batches of changes, and shared journal cache 318 acts as a buffer of changes, thus, giving flexibility in the timing of HNSW index maintenance operations. Shared journal cache 318 may also be used for journaling during online creation of the HNSW index. Regarding (3), the HNSW index may be periodically persisted to persistent (non-volatile) storage using a checkpoint mechanism. Also, because shared journal cache 318 is persisted to shared journal table 324, changes are guaranteed to be persisted from the HNSW checkpoint System Change Number (SCN) to the latest committed vector changes. Thus, upon restarting a compute instance after a crash, the HNSW index may be restored to memory from the checkpointed image, and the changes from shared journal table 324 may be applied to the restored image in a lazy manner.

Disk storage 320 also stores ROWID-VID table 322, which is a mapping table that maps row IDs to vector IDs. The mapping table may be used to identify vectors that are deleted or those vectors that pass an attribute filter. One reason for using VIDs instead of rowIDs in a vector index is because VIDs are much smaller in size than rowIDs.

### Hnsw: Example Data Implementation

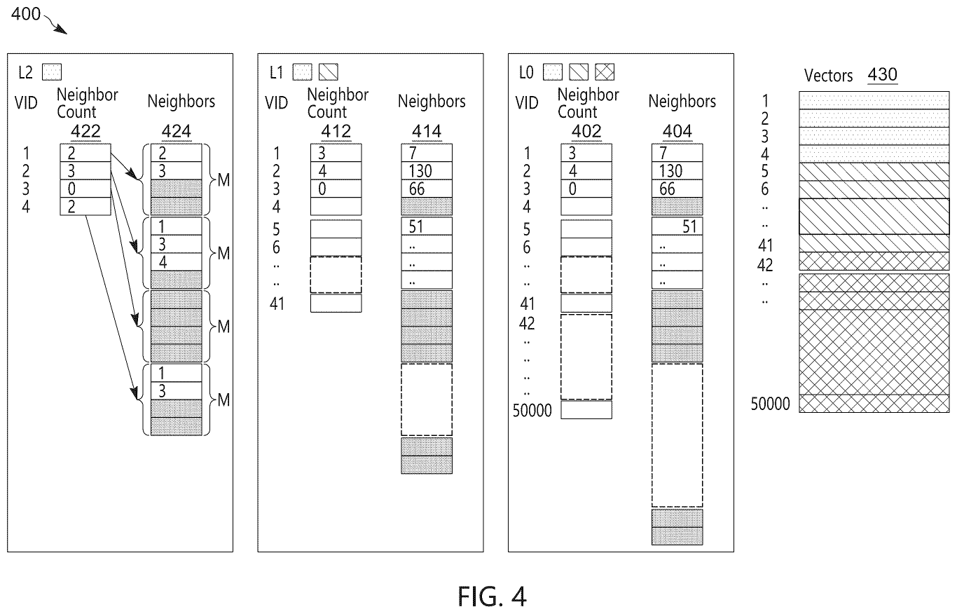

FIG. 4 is a block diagram that depicts organization of an HNSW index 400 according to an example embodiment. In this example, HNSW index 400 comprises three layers, layers 0-2. Each layer stores data about a set of vertices and contains a neighbor count array for the set of vertices and a neighbors array for the set of vertices. Thus, layer 2 includes a neighbor count array 422 and a neighbors array 424. Each entry in neighbor count array 422 corresponds to a different vector that has been assigned to layer 2. Each position of neighbor count array 422 is an index value that points to a position within vectors array 430, which stores vector embeddings for the vertices in layer 0. Thus, the first position in neighbor count array 422 corresponds to the vector in the first position of vectors array 430, the second position in neighbor count array 422 corresponds to the vector in the second position of vectors array 430, and so forth. The same is true for neighbor count array 412, neighbors array 414, neighbor count array 402, and neighbors array 404. As FIG. 4 indicates, the number of vertices assigned to each layer increases from the top-most layer to the bottom-most layer. Also, a vertex that appears in a top layer (e.g., vertex with VID 1) or in an intermediate layer also appears in each layer below that layer.

In an embodiment, vectors array 430 is constructed by assigning VIDs to vertexes during their respective insertion into a layer of HNSW index 400. Thus, the vertices (and, thus, their corresponding vectors) that are assigned to the highest layer will have lower VID/position numbers (and will be inserted first into HNSW index 400) relative to vertices that are assigned first to a lower layer.

Each entry in neighbor count array 422 includes a value that indicates a number of neighbors that the corresponding vertex has been assigned during the index construction phase. Each (“referencing”) entry in neighbor count array 422 also references or points to an (“referenced”) entry in neighbors array 424 where at least one neighbor of the corresponding vertex is identified. That referenced entry may be the first entry of a set of entries that correspond to the neighbors of the referencing entry. Because each vertex has at most M neighbors, the remaining neighbors of the corresponding vertex are listed in entries subsequent to that first referenced entry, up to M−1 entries away from the first entry. As the example of FIG. 4 indicates, some vertices may have less than M neighbors.

Neighbors array 424 includes vector IDs of neighbors of vertices indicated in neighbor count array 422. While neighbors array 424 is presented as a single array, neighbors array 424 may be implemented as a single array or as multiple smaller arrays (e.g., of size M) but are concatenated together for ease of description.

### Hnsw: Updates to Hnsw Index

After an HNSW index is built, one or more changes may be made to the underlying vector data. Such changes may be initiated by DML statements. One way to process the one or more changes is to buffer those changes by storing the changes in a separate table, such as shared journal table 324. Eventually, it becomes necessary to apply those changes to the HNSW index. Another way to process the one or more changes is to apply the changes immediately to the HNSW index, without buffering. However, immediately applying changes made by a transaction means that the transaction “pays” the overhead of maintenance, thus slowing down the transaction. Regardless of which approach is used to process changes, whether in batches or incrementally as the changes are received, it is preferred to not rebuild the HNSW index “from scratch,” since that is an expensive operation in terms of time and resources.

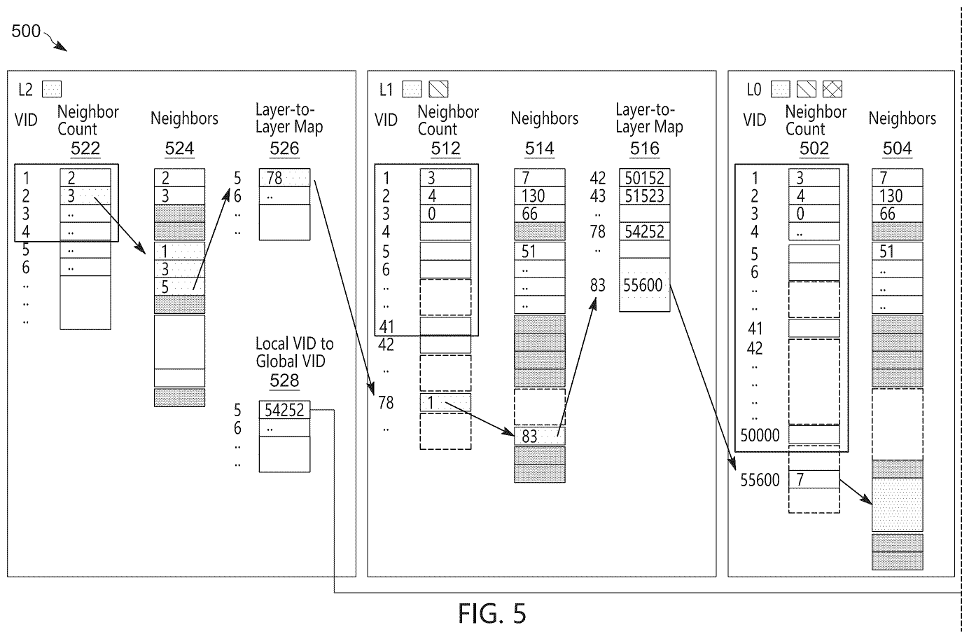

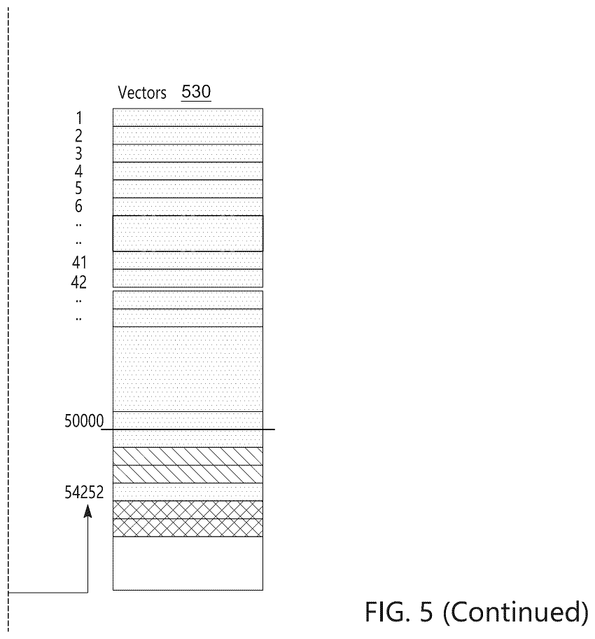

FIG. 5 is a block diagram that depicts an updated version of an HNSW index 500 after multiple inserts have been made into that index according to an example embodiment. HNSW index 500 is the updated version of HNSW index 400 and includes the same data structures as depicted in FIG. 4 (except with updated reference numerals, such as 504, 514, and 524) as well as additional data structures. Layer 2 (the top-most layer) has layer-to-layer map 526 and local VID to global VID map 528, while layer 1 has layer-to-layer map 516. In response to a batch update or an incremental update, it may be automatically determined (e.g., by an index updating component) that a vertex for the new vector is to be inserted into layer 2. A naïve approach would be to assign that new vertex to the next available VID in vectors array 530 (e.g., 50001) and to use that VID in the other layers of HNSW index 500. However, neighbor count array 522 has a limited number of positions and it would be a waste of space to assign the new vertex to have a VID of 50000+, because then neighbor count array 522 would have thousands of unused entries.

In the depicted embodiment, a new vertex/vector is assigned multiple local VIDs, each for a different layer of HNSW index 500. Thus, the next available VID in neighbor count array 522 is determined. In this example, that next available VID is 5. However, VID 5 is already assigned to another vector in vectors array 530. Nevertheless, the new vector is also assigned the next available VID in vectors array 530, which is, in this example, 54252. Therefore, the new vector has two VIDs: 5 and 54252. In response, local VID to global VID map 528 is updated to associate the “local” VID of 5 (local to layer 2) to the “global” VID of 54252.

Because this new vertex is assigned to layer 2, a vertex of the new vector is also assigned to layer 1. Similarly, because neighbor count array 512 has a limited number of positions and it would be a waste of space to assign the new vertex to have a VID of 54252 in layer 1, the next available VID in neighbor count array 512 is determined. In this example, that next available VID in layer 1 is 78. Although not depicted in FIG. 5, layer 1 also has a local VID to global VID map, as in layer 2, so that vector distances may be computed during a search. Further, in this example, the new vertex in layer 1 has a neighbor (in layer 1) that is assigned VID 83 and, according to layer-to-layer map 516, is mapped to VID 55600 in neighbor count array 502. Thus, presuming that HNSW index 400 had fifty thousand vectors when it was built, the vector assigned VID 55600 was added to the HNSW index sometime after HNSW index 400 was built.

In an embodiment, deletes are not propagated to higher layers. Instead, deleted vertices are masked only in the lowest layer of the HNSW index.

### Multi-Snapshot Hnsw Index

As described herein, an HNSW index is a multi-layer in-memory neighbor vector graph built from vectors. The HNSW index is also built as of a specific point in time, which may be determined using timestamps or SCNs. The time at which an HNSW index is built is referred to as the “build SCN.” Thus, an HNSW index may be considered a “snapshot” of the index. As DML statements are applied to the base table of vectors upon which the HNSW index is built, this snapshot becomes stale, leading to slower query performance due to ever-increasing disk-based shared journal access. Therefore, the most recent snapshot eventually should be refreshed. Refreshing a snapshot refers to updating a snapshot based on changes that have been made to the base table of vectors since the build SCN of the snapshot.

There are two approaches for refreshing a snapshot: a tic-toc snapshot approach and a multi-snapshot approach. In the tic-toc snapshot approach, at most two snapshots of the HNSW index are maintained or tracked: the current active snapshot and a new snapshot that is built in the background that eventually becomes visible to vector queries once fully built. Once the new snapshot is available, vector queries that have a timestamp or SCN that is after (timewise) the new snapshot's build SCN are directed to the new snapshot. Vector queries that began to be processed against the old snapshot eventually end (whether terminated due to an error or fully processed with a query result generated). Once a retention threshold has elapsed, it is guaranteed that VDBMS 100 will not receive any vector queries with scan SCN that is less than the new snapshot's build SCN. The old snapshot may be deleted after the lapse of that retention threshold.

In the tic-toc snapshot approach, long-running queries (or even large retention thresholds) can prevent the reclamation (or deletion) of the old snapshot, which also prevents the creation of a newer snapshot since only two snapshots are allowed. The tic-toc snapshot approach may be generalized to a multi-snapshot design where snapshots are periodically created and tracked.

### Multi-Snapshot Hnsw Index: Efficient Creation of Snapshots

In an embodiment, snapshots of an HNSW index are created incrementally. This means that snapshot i+1 is created by applying changes in the shared journal that is associated with the HNSW index and, thus, stores changes that have a timestamp that is after the build timestamp of snapshot i. In other words, the changes in the shared journal are associated with timestamps, or SCNs, in the SCN range [Snapshot #i creation SCN, Snapshot #i+1 chosen creation SCN] and are applied to snapshot i. For example, a snapshot creation process (e.g., executing in the vector database server 110) identifies the build SCN of snapshot i, identifies a current SCN that will be the build SCN of snapshot i+1, identifies (in the shared journal) all changes associated with an SCN between those two SCNs, and applies those identified changes to snapshot i (or a copy thereof), resulting in snapshot i+1. Thus, creating a new snapshot from an old (or most recent) snapshot may involve copying the old snapshot (with all its vertices and neighbor lists) and modifying that copy.

There are two main types of changes that are to be accounted for when creating a new snapshot: deletes of vectors and inserts of vectors. (An update of a vector may be implemented as a deletion of the vector followed by an insert of a new vector that replaces the vector.)

### Vector Deletes

Deletes may be handled in one of multiple ways. In a first deletion technique, for each deletion of a vector, a vertex, in the new snapshot, is identified that corresponds to the deleted vector, and that vertex is marked as deleted or masked off. However, the neighbor lists of that vertex remain unchanged. Then, during query execution, a Top K traversal of the new snapshot skips or avoids returning those marked vertices, which process is similar to the handling of the delete filter.

In a second deletion technique, neighbor lists (copied from the most recent snapshot) are adjusted to remove, in the new snapshot, the deleted vertices. Whenever a vertex V is removed, it affects the vertices that had V as one of their 2M neighbors. The set of all such vertices comprises the proximal graph. Thus, a proximal graph comprises (1) a first set of vertices, in a snapshot, that are deleted based on changes indicated in the shared journal and (2) a second set of vertices, in the snapshot, each of which is connected to at least one vertex in the first set of vertices. For each vertex in the second set, an alternate neighbor is chosen to replace V. Alternatively, each vertex in the second set is “re-inserted” into the graph. The insertion algorithm takes care of adjusting neighbor lists.

### Vector Inserts

Regarding vector inserts, inserts are handled using the insertion process described herein. The number of inserts and/or the percentage of all vectors that are inserted may be factors in determining whether to rebuild the HNSW index instead of creating a new snapshot from a current snapshot.

In an embodiment, a copy-on-write technique is used to create new copies of neighbor lists that have been modified. For neighbor lists that have not been modified, the memory from the previous snapshot is shared in the new snapshot. This ensures that the memory overhead of the new snapshot is minimal.

As depicted in FIG. 4, each layer has a neighbor count array and a neighbors array. A neighbor count array is essentially a “source array.” Index 1 in the source array is vertex ID 1, index 2 in the source array is vertex ID 2 and so on. The neighbors array stores up to M (or 2M) neighbors per source vertex. There is a pointer from every source array vertex to its neighbors (specifically, the first of its M neighbors).

With that context, using the copy-on-write technique when creating a new snapshot, a new copy of the entire source array is created in each layer. Essentially, every source vertex “points” to the existing neighbor list (unchanged vertex) or to a new neighbor list (because the source vertex's neighbors have been affected). Because a new copy of the source array is created, each vertex points to its old neighbor lists by default. If the neighbors of a source vertex have changed, then a copy-on-write is performed for the neighbor list of that source vertex. This means that a copy of the M neighbors is created elsewhere, the old deleted neighbors are removed from that copy, new neighbors are added to the copy, and the pointer of the source vertex entry to this copy is updated. Thus, the set of unchanged neighbor lists are pointed to by the source array of snapshot 1 and snapshot 2. This neighbor list memory is shared. For the changed neighbor lists, the source array for snapshot 1 points to a different memory region than the source array for snapshot 2.

In a related embodiment, neighbor lists are broken up into chunks, such as segments, (e.g., of 1 MB), rather than a single contiguous entity of vertices. Within each chunk, if any neighbor list is changed, then a copy-on-write is performed on the entire chunk.

When a snapshot is reclaimed, that region of M neighbors within the chunk may be marked as free, and this memory can be used to perform a copy-on-write on the neighbor list of some other snapshot.

In summary, in response to determining to generate a new snapshot of an HNSW index, a first set of vertices, in the latest (or most recent) snapshot, whose neighbor lists have not changed since that snapshot is identified. Also, a second set of vertices, in the latest snapshot, whose neighbor lists have changed since that snapshot is identified. Memory, for the latest snapshot, that stores neighbor lists of the first set of vertices is shared with the new snapshot. For example, the upper two layers of the two snapshots may be identical and, therefore, completely shared when traversing/scanning either snapshot for different vector queries with different timestamps. Unused memory is allocated for the new snapshot in order to store the updated neighbor lists of the second set of vertices. (The source array is a new piece of memory for each snapshot.) This allocation may involve copying the memory, for the latest snapshot, that stored the neighbor lists of the second set of vertices into the unused memory for the new snapshot and then modifying the neighbor lists so that they no longer include deleted vertices.

### Schema Definitions

A schema is a blueprint or structure that defines how data is organized and how relationships among data are managed.

### Global Table Schema

Embodiments provide a global catalog table schema for a global table that tracks checkpoints for different HNSW indexes. For example, a catalog table, VECTOR$INDEX$CHECKPOINTS, is created to track the checkpoints. The catalog table can be shared across nodes, instances, etc. A schema definition of the catalog table describes the fields, such as the attributes or columns, for rows/records of the catalog table.

One field can be for an INDEX_OBJN, which is an index object number that uniquely identifies the HNSW index. The index object number tracks the HNSW index to which a particular checkpoint corresponds.

Another field can be for an INDEX_OWNER_ID, which is the owner ID for the HNSW index. The owner can be a tenant, such as a group of users who share common access on an instance, can be the root user, such as an administrative account, can be a user of multiple users in a tenant, such as a user that corresponds to a particular HNSW index, or can be any other owner.

Another field can be for a CHECKPOINT_ID. The CHECKPOINT_ID is a monotonically increasing identifier that tracks various checkpoints for an HNSW index.

Another field can be for a CHECKPOINT_SCN. The CHECKPOINT_SCN is the System Change Number (SCN) as of which the HNSW index checkpoint was taken, such as a timestamp of the time at which the HNSW index checkpoint was taken.

Another field can be for a CHECKPOINT_TYPE. The CHECKPOINT_TYPE is the type of checkpoint, such as a full checkpoint or an incremental checkpoint.

Another field can be for a VERSION_NUMBER. The checkpoint format may change in between releases, such as database version releases and/or updates. The version number can be used to decide whether to reload the HNSW index using a particular checkpoint. For example, disk checkpoints persist across releases with format changes. When the format changes, new code may not understand a prior checkpoint format, can use the version number to reject the checkpoint because the old format is no longer valid, and can rebuild the HNSW index from scratch to avoid the need to maintain backward compatibility.

Another field can be for a TABLESPACE_NUMBER for the tablespace that stores the disk checkpoints. For example, a database can be broken into tablespaces that each include different information. A user can have a certain tablespace that stores the disk checkpoints, and the tablespace number can identify the tablespace. The catalog table can also include other fields.

### Per-Index Table Schema

Embodiments can also provide a per-index table schema for a per-index table that stores all the disk checkpoints for a particular HNSW index. The per-index table can be considered an auxiliary table and is created per HNSW index to track the disk checkpoints, where each HNSW index has its own table. A schema definition of the per-index table describes the fields for rows/records of the per-index table.

One field can be for a CHECKPOINT_ID, which is a monotonically increasing ID that tracks various checkpoints for an HNSW index. The checkpoint ID can be a foreign key used with the INDEX_OBJN and INDEX_OWNER_ID to join with the global catalog table described above. The checkpoint ID can be a value that is incremented to identify a new checkpoint that was generated after an HNSW index was refreshed and the old checkpoint was discarded.

Another field can be for a LAYER, which is the HNSW layer to which a checkpoint row/record belongs. For example, a checkpoint can be broken into multiple BLOBs, each layer can have its own BLOB, and the layer value can identify the layer to which a BLOB of a row belongs.

Another field can be for a UNIT_ID. The Layer 0 checkpoint, the checkpoint of the bottom layer, can become very large. Other lower layers may also be large. The serialized data for large layers can be broken down into various units, such as multiple BLOBs, to support parallel serialization and deserialization, such as for loading, populating, and reading multiple BLOBs in parallel. The unit ID can identify each unit of a large layer that has been broken down into units. For higher layers, only one unit may exist per layer because high layers may be relatively small. For example, the number of vertices in higher layers of the HNSW index is an exponentially decaying fraction of the total number of vertices, which results in smaller higher layers.

Another field can be for a FLAG. The flag indicates what information is stored in a row, such as what data is included in a BLOB of a particular row. There can be one or multiple flag fields. The values of the flag can indicate that information stored in the row is:
An HNSW Index Header. Each row in the table corresponds to different metadata to keep the row isolated. The HNSW index header includes the metadata about the HNSW index, such as the number of vertices, the number of segments, the number of layers, the VIDs, the encoding of the vectors, etc. For example, depending on the version of the checkpoint or of a snapshot, different policies can decide the shape of the index or the shape of the hierarchy of the index, and depending on which policy was used, different metadata can be used to restore the index, convert the index to the new version, etc. The index header can be read first when accessing information from the per-index table.
A Layer-to-Layer Vertex ID Map.
A Layer Vertex ID to Neighbor Map.
Deleted Vertex IDs and Deleted Vectors. Vectors may have been deleted from the base table but not from the HNSW index. The checkpoint can store the deleted vertex IDs and their vectors. The checkpoint maintains the deleted vectors because the deleted vectors are still part of the index and are used for queries to allow the queries to continue to navigate neighborhoods of the deleted vectors until the vectors are removed as part of a full repopulation of the HNSW index or application of the deleted vectors to the HNSW index. Thus, the information about the deleted VIDs allows for queries to explore the neighborhood of deleted vectors while also identifying the deleted vectors as deleted.

Another field can be for the DATA stored in the row. The serialized data of the row is stored as a BLOB. Possible BLOB formats are described in a description of checkpoint formats below. The per-index table can also include other fields.

### Checkpoint Formats

Embodiments can provide checkpoint formats, such as full checkpoint and incremental checkpoint formats for an HNSW index.

### Full Checkpoints

A full checkpoint is an image of the current HNSW index. The full checkpoint contains graph edges for all vertices that are currently indexed in the HNSW index as of the checkpoint SCN. The current HNSW index can have multiple snapshots that were taken at different times, and a full checkpoint reflects the snapshot at the time the full checkpoint is made. Every edge that exists in the current snapshot is checkpointed (or reflected) in the full checkpoint even though the current snapshot may be borrowing vectors and edges from a previous snapshot. The full checkpoint can be a serialized image including the information described above, such as the HNSW index header, the deleted vertex IDs and deleted vectors, the layer-to-layer vertex ID map, and the layer vertex ID-to-neighbor map. Thus, the serialized formats for a full checkpoint include layer-to-layer vertex ID maps for each layer, layer vertex ID-to-neighbor maps for each layer, and a deleted vectors list that are described below.

Segments are created along with the creation of a new multi-layered HNSW index. A segment has a fixed memory size and tracks information about a group of vertices. Multiple segments are created to track information about the vertices that are being indexed as part of the HNSW index creation. A segment can track the neighbor vertex IDs of a batch of vertices, can track vertex ID mapping of vertices in one layer to vertices in another layer for a batch of vertices, and/or can track other information.

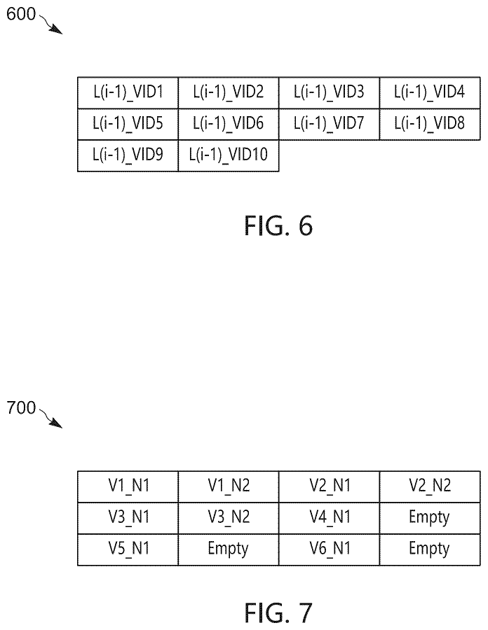

FIG. 6 is an illustration of a Layer (i) vertex ID-to-Layer (i−1) vertex ID map checkpoint format 600 according to an example embodiment. In the format 600, the vertex IDs are laid out one by one in an array in the order of the vertex IDs in particular Layer (i). A set of vertices can form a segment, which is in a unique piece of memory for the index. The physical segments storing the vertex ID mapping are laid out one after the other in the disk checkpoint. In this example map, L(i−1)_VID1 through L(i−1)_VID4 represent a serialized image of a segment with four vertices, L(i−1)_VID5 through L(i−1)_VID8 represent a serialized image of a segment with four vertices, and L(i−1)_VID9 and L(i−1)_VID10 represent a serialized image of a segment with two vertices. For example, in the map, the vertex with VID1, such as the vertex with VID=1, in Layer (i) is mapped to the vertex in Layer (i−1) with a vertex ID stored in L(i−1)_VID1, the vertex with VID2 in Layer (i) is mapped to the vertex in Layer (i−1) with a vertex ID stored in L(i−1)_VID2, etc. Storage of the Layer (i) vertex ID in the checkpoint format is not necessary because it is implicit in the ordered list of VID1, VID2, etc. To elaborate, L(i−1)_VID1 stores the vertex with vertex ID in Layer (i−1) corresponding to the vertex with VID1 in Layer (i), which maps VID1 in Layer (i) to the stored vertex ID of the corresponding vertex in Layer (i−1). For example, if L(i−1)_VID1 is “3”, the vertex with VID1 in Layer (i) maps to the vertex with a vertex ID of “3” in Layer (i−1). This map can take up the full storage allocated for the map in the checkpoint. This map is not necessary for the bottom layer, Layer 0, because there is no layer below the bottom layer. For the bottom layer, a vertex ID to a table Row ID mapping is tracked. The mapping is tracked in a separate table for the HNSW index and thus, there is no need to checkpoint it.

FIG. 7 is an illustration of a Layer (i) vertex ID-to-neighbor map checkpoint format 700 according to an example embodiment. The neighbor vertices are laid out in the order of vertex IDs. A maximum number of neighbors, M, can be a parameter set during HNSW index creation. In the example checkpoint format 700, the maximum number of neighbors, M, is two, such as for neighbors N1 and N2, but the value of M can be higher. For example, if M is 32, then there will be 32 slots, with one slot for each neighbor. If a vertex does not have all the M neighbors, then there can be empty slots. All vertices with vertex IDs from 1 to the maximum number of vertex IDs for a given layer have a presence in the disk checkpoint. If a vertex ID is not present in the index, then the serialized neighbor list may be stored as invalid vertex IDs.

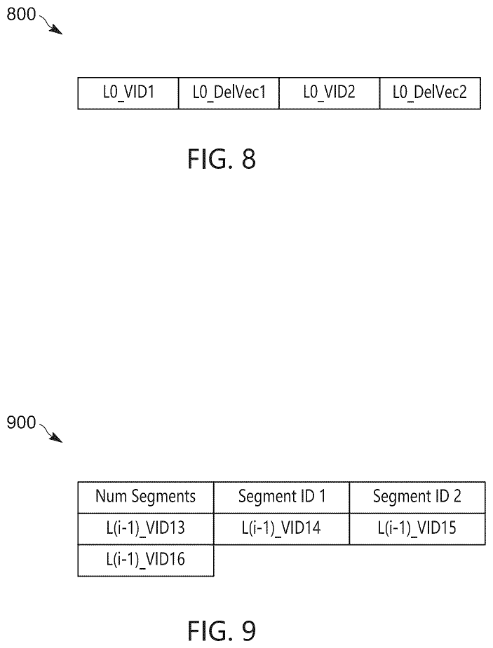

FIG. 8 is an illustration of a deleted vectors list checkpoint format 800 according to an example embodiment. The deleted vectors are laid out one after the other in a serialized BLOB. The deleted vectors are deleted at the bottom layer, Layer 0, and correspond to higher layers. The deleted vertices are masked off during an HNSW index search because they have been deleted. In format 800, the vertex ID is stored followed by the deleted vector. The deleted vector will not be present in the base table and, thus, is persisted in the disk checkpoint. The deleted vector is loaded into the index upon restart because the deleted vector is used during index traversal.

### Incremental Checkpoints

Every time a full checkpoint is taken, the full HNSW index is serialized. Taking a full checkpoint on an HNSW index refresh may take a long time, especially if there are many vectors indexed in the layered HNSW index. This may lead to an increase in input/output (IO) and CPU consumption per checkpoint, fewer number of checkpoints being taken, and the checkpoint quickly becoming stale. Checkpoints can quickly become stale in the presence of high transaction activity, which results in the reloaded HNSW index after an instance restart being very old in terms of transactions.

A full checkpoint can be created instead of an incremental checkpoint if the HNSW has gone through a full rebuild or if many incremental checkpoints have been taken since the last full checkpoint. An incremental checkpoint can be chosen over a full checkpoint when there is a significant workload.

Incremental checkpoint creation is faster than full checkpoint creation because incremental checkpoints only include vertices that got added and/or deleted and the neighborhood that was modified, such as via a copy on write mechanism, during an HNSW snapshot creation. Incremental checkpoints are made after a full checkpoint and go together with incremental HNSW snapshots, which are snapshots that only track changes since a previous HNSW snapshot. Full checkpoints for an HNSW index are large, so the use of an incremental checkpoint provides additional time saving, such as by dropping the time from hours for a full checkpoint down to potentially minutes for an incremental checkpoint. For example, a full checkpoint creation takes much longer than incremental checkpoint creation as the incremental checkpoint creation remembers a sub-set of the graph. The time saving is because only vertices that underwent a neighborhood change are stored in an incremental checkpoint. Also, double the disk space can be required to remember a new full checkpoint as compared to the old full checkpoint. Incremental checkpoints can be more space efficient in the shorter term by delaying the generation of the new checkpoint.

Incremental checkpoints may be taken less often than snapshots when there is significant workload. Also, the goal of snapshots can be different from the goal of incremental checkpoints. For example, the goal of snapshots can be for indexing the vectors into the index and making queries run faster. The goal of checkpoints can be for duplication and reload operations. Thus, snapshots may be taken more often than incremental checkpoints.

The incremental checkpoint can include a delta Layer (i) vertex ID-to-Layer (i−1) vertex ID map, a delta Layer (i) vertex ID-to-neighbor map, and a delta deleted vectors list, where “delta” indicates only the vectors or segments that have changed are included in the incremental checkpoint. Serialized formats for an incremental checkpoint are described below.

FIG. 9 is an example illustration of a delta Layer (i) vertex ID to Layer (i−1) vertex ID map checkpoint format 900 according to an example embodiment. The layer-to-layer map checkpoint format 900 includes the number of segments in the map, segment IDs, and vertex IDs. A segment can include a contiguous set of vertices that form a neighborhood for a particular vertex. In an example format 900, L(i−1)_VID13 and L(i−1)_VID14 represent a serialized image of Segment ID1 with two vertices and L(i−1)_VID15 and L(i−1)_VID16 represent a serialized image of Segment ID2 with two vertices. Only the segments that had a vertex ID changed in an HNSW snapshot are tracked. Vertex IDs can be reused and thus some segments may have undergone a copy on write process described below. At higher layers, the layer-to-layer map can implement a copy on write process or a full map can be created because the map can be smaller at higher layers.

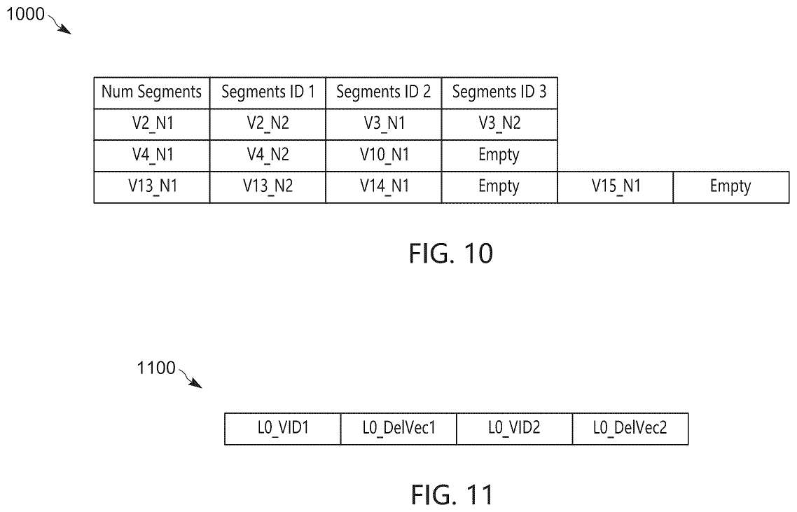

FIG. 10 is an example illustration of a delta Layer (i) vertex ID-to-neighbor map checkpoint format 1000 according to an example embodiment. The neighbor map checkpoint format 1000 includes the number of segments in the map, segment IDs, and vertex IDs. The neighbor map checkpoint format 1000 includes vertex neighbors that have changed and also neighbors that are new. It tracks the segments that correspond to vertices that underwent a neighborhood change in the HNSW snapshot.

In the shown example, the segment with Segment ID 1 tracks the neighbors of vertex V2 and vertex V3. For example, vertex V2 can be an existing vertex that is tracked in the incremental snapshot because it has a new set of neighbors. Vertex V3 can be a new vertex with corresponding new neighbors. One of the vertices V2 or V3 may also be included if it has not changed but is in the same segment of a vertex that has changed.

It is noted that if a vertex in a segment was deleted, that vertex may not exist in the segment, but there still may be a slot for a null pointer if the vertex ID was not reused. The corresponding portion of the segment may be filled with null values, such as zeros, for serialized alignment purposes. For example, if V3 was deleted, the corresponding section can include null values in the segment of the incremental checkpoint if the neighbors of V2 were changed. More complicated indications of null vectors in a segment can use a bit vector at the beginning indicating what is null and not null or can switch encoding from segments to vector ID and payload, which can allow for compression.

The segment with Segment ID 2 tracks the neighbors of vertices V4 and V10. The vertices in the segment are typically contiguous, so the vertices between V4 and V10 would typically also be included, even if their neighbors did not change when the neighbors of V4 or V10 changed. The shown scenario may exist if vertices V5-V9 were deleted or vertex ID V10 was reused.

The segment with Segment ID 3 tracks the neighbors of vertices V13, V14, and V15. In a possible implementation, the segments with vertices V2, V3, V4, and V10 may have been included in the incremental checkpoint because their neighborhood changed with the addition of V13-V15. Vertex V1 may not have been included in the incremental checkpoint because its neighbors did not change. V1 would have to be brought in from a full checkpoint to create the full index.

FIG. 11 is an example illustration of a delta deleted vectors list checkpoint format 1100 according to an example embodiment. The delta deleted vectors list checkpoint format 1100 can include only the vertices that were deleted since the last checkpoint. The vertex ID is stored followed by the deleted vector. The whole list of deleted vectors may also be included in the incremental checkpoint instead of the delta list because there may not be many deleted vectors relative to the vectors in the other maps.

### Snapshots and Segments

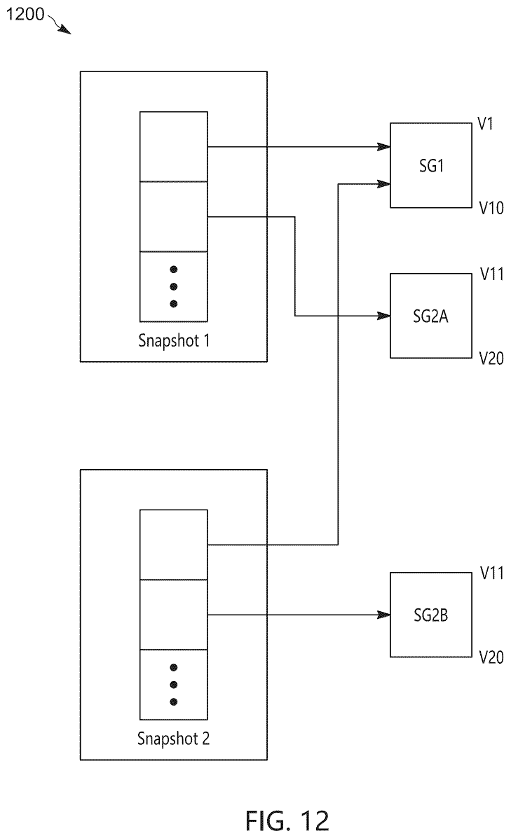

FIG. 12 is an illustration 1200 of snapshots and segments according to an example embodiment. The snapshots include Snapshot 1 and Snapshot 2. As discussed above, an HNSW index can have multiple snapshots that were taken at different times. A source array in snapshot 1 references segments SG1 and SG2A. A source array in snapshot 2 references segments SG1 and SG2B. Segment SG1 includes vertices V1-V10 and segments SG2A and SG2B includes vertices V11-V20.

Snapshot 2 only shares segments with Snapshot 1 that did not undergo a change. For example, when Snapshot 2 is created, vertices V1-V10 have not changed. However, the vertices V11-V20 have changed, such as by undergoing a copy on write because of new vertex additions or vertex deletions. Thus, Snapshot 2 shares segment SG1 with Snapshot 1, but references segment SG2B instead of segment SG2A.

As mentioned above, incremental HNSW checkpoints may be made after a full checkpoint. Incremental checkpoints go together with incremental snapshots and only track the vertices that underwent changes. An incremental checkpoint checkpoints (or identifies) the vertices that were added/deleted, and the neighborhood that was modified, such as by vertices being deleted or added during a copy on write process during the HNSW snapshot creation. In effect, an incremental checkpoint takes a persistence of some parts of the HNSW index instead of taking the persistence of the full HNSW index. For example, a full checkpoint includes segments SG1 and SG2A, and the subsequent incremental checkpoint only includes the changed segment, SG2B. When the checkpoints are applied, they can be applied in a reverse order. For example, the latest incremental checkpoint can be applied at the beginning and the full checkpoint can be applied at the end. The latest incremental checkpoint can first be applied, and the missing segments can be applied from each earlier checkpoint going back to and including the full checkpoint. The segments that were modified using copy on write are tracked at a layer-to-layer level to apply the checkpoints in the reverse order. Alternatively, the checkpoints can be applied in the order in which they occurred, but applying the checkpoints in reverse order can reduce processing, such as reducing I/O's, by rejecting the full checkpoint segments that were already loaded from the incremental checkpoint.

### Copy on Write

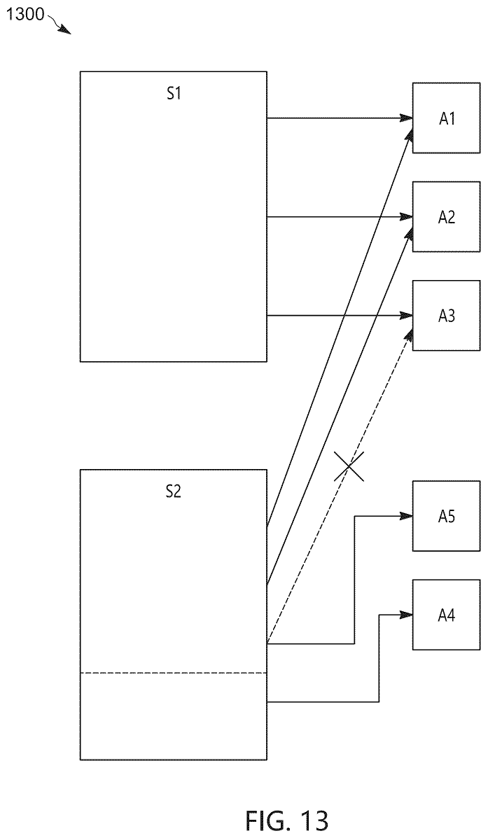

FIG. 13 is an illustration of a copy on write process 1300 according to an example embodiment. A copy on write process avoids copying and storing every segment for incremental checkpoints and snapshots by using pointers to share arrays of elements, such as segments, that have not changed between the checkpoints and snapshots. For example, an HNSW index comprises a large, segmented array, and elements of the segmented array have pointers to an adjacent list. When a new version of the index is created, the entire source array is needed. When a new snapshot is created, the source array is cloned with a mapping between vertices and their neighbors. Then changes are made including vertex insertions, additions, etc. When an element is inserted, other existing elements are changed to point to the new element. Low-order bits are used to indicate which elements were copied. When a new element is allocated, a pointer is changed in the source array to point to the new location, and the pointer is flagged with the low-order bits to ensure the correct address is found during searches and to indicate it has been updated via copy on write.

The copy on write process 1300 shows snapshots S1 and S2. The snapshot S1 includes an initial source array of pointers. Each of the entries in the initial source array is an entry for a specific vertex, and it has a pointer to an adjacent list, such as adjacent lists A1, A2, and A3, which can be adjacent neighbor lists. The snapshot S2 is created after a vector is inserted. The snapshot S2 includes a new source array that initially includes data, such as the pointers to A1-A3, copied from the initial source array. The new second snapshot S2 in creation also has more space to ingest new vectors. There is one more vector in the snapshot S2 that points to adjacent list A4. This vector needs to be connected to the rest of the index, so an ingestion procedure is performed which searches for the neighbors of the vector. When the search is performed the procedure may notice that a back edge of an existing vector should be connected to the new vector. In this example, the existing vector was using adjacent list A3 and the pointer is updated to point to a newly allocated adjacent list A5. To know this operation was performed on the old snapshot, a bit can be added to the corresponding pointer to indicate it was updated using copy on write.

Thus, the new snapshot S2 reuses most of the adjacent lists but has new information that is separated from the old snapshot S1. Whatever queries are running on the old snapshot S1 can still run. The copy on write process 1300 provides two different views of the index, using minimal additional memory. The copy on write process 1300 can also be useful when one of the snapshots is dropped because it is no longer necessary to maintain unused information. For example, if snapshot S1 is dropped, adjacent lists A1 and A2 are still being used, but adjacent list A3 is no longer in use and can be freed for other use and this can also be useful for implementing garbage collection procedures. In summary, the snapshots are arrays of pointers with snapshot S2 being a modified copy of snapshot S1. Extra bits in the pointers are used to remember which parts were modified. This helps avoid making a clone of a modified part a second time.

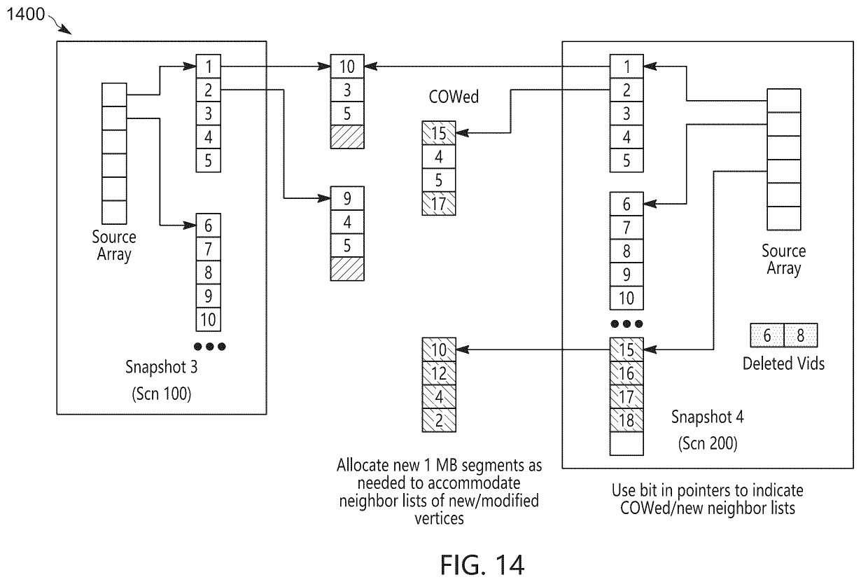

FIG. 14 is an illustration of a copy on write process 1400 while creating snapshots according to an example embodiment. Snapshot 3 is created as of SCN 100 and tracks vectors with vertex IDs 1-14 (vertex IDs 11-14 not shown). Vertex 1 has three neighbors (out of a maximum of four neighbors) with vertex IDs 10, 3, and 5. Vertex 2 has three neighbors with vertex IDs 9, 4, and 5.

A new incremental snapshot 4 is being created at SCN 200 with additional vectors that are assigned vertex IDs 15-18. Vectors with vertex IDs 6 and 8 were deleted between SCN 100 and SCN 200. The deleted vectors for a particular snapshot are tracked as bit vectors with indices that correspond to the vertex IDs that were deleted as part of snapshot 4.

The neighborhood for vertex 1 was unchanged in snapshot 4. Thus, the neighborhood memory is shared between the two snapshots. The neighborhood for vertex 2 has changed due to the addition of vertices 15 and 17. Thus, the neighborhood memory for vertex 2 cannot be carried over from snapshot 3 and new memory allocation is needed for the vertex 2 neighborhood.

New memory segments, such as 1 MB segments, are allocated for the neighbor lists of added vertices 15 and 17. New memory segments are also allocated for new and modified vertices. A bit in the pointers from the vertices to the corresponding neighborhood lists can be used to indicate the vertices, segments, and/or neighbor lists that were created based on a copy on write operation.

### Checkpoint Policies

Checkpoint policies can be used to for efficient loading of the HNSW index after an instance restart from a shutdown. This is because if the checkpointed copy of the index being restored is old, and several transactions have made modifications to the vectors since the checkpoint SCN, then queries will pay a significant penalty due to the need to scan the modifications from a shared journal. For example, if the checkpoint is older than the latest snapshot, then the graph reload may take a longer time because it requires re-creation of create the graph for the delta between the last known checkpoint and the latest snapshot. Nonetheless, the desire to frequently checkpoint can be balanced with the overhead in terms of CPU and IO required to create and persist an HNSW checkpoint. For one policy, the first full checkpoint can be taken in line with the HNSW index creation. This can be done for HNSW indexes that have checkpointing enabled.

For another policy, each time the HNSW index is refreshed, a checkpoint can optionally be created. There can be two types of HNSW index refreshes: full repopulation and incremental snapshots. A full repopulation of the HNSW index indexes un-indexed vectors that are in a shared journal table. It is implemented using a double buffering mechanism where the static HNSW index built as of an older time is available for queries. Once the new HNSW index is ready, queries can leverage the new index built as of a newer time. A full checkpoint can optionally be created when the HNSW index undergoes a full repopulation.

An incremental snapshot creation of the HNSW index involves adding newly inserted vectors into a previous snapshot of the HNSW index using a copy on write mechanism. Additionally, deleted vectors are tracked in the snapshot using a deleted vertex ID array. The incremental snapshot creation approach is faster than a full repopulation because the neighborhood selection is done for a small percentage of vertices. An incremental checkpoint can be created when an incremental snapshot is created for the HNSW index. The incremental checkpoints may be taken with every incremental snapshot, or they may be created in a delayed manner. Use of the incremental checkpoint is faster than a full checkpoint. However, a full checkpoint may be triggered once the number of incremental checkpoints goes above a threshold. This helps in reducing the time taken to reload the index after a restart.

For another policy, checkpoints may be taken before a planned shutdown, but this may put additional load on a system because checkpoints may not be spread across time and the checkpoint must be properly planned to ensure there is enough time to make the checkpoint before the shutdown. Another approach is to take a full or incremental checkpoint once for every threshold number, R, of refreshes of the HNSW index. This can help keep the CPU usage bounded. The value of the threshold R can be chosen based on various heuristics described below.

The value of the threshold R can be chosen based on the availability of other HNSW index copies. For example, in a cluster, if the HNSW index is duplicated, then other copies provide high availability of the HNSW index, and hence, the crash of one instance is not significant. In such scenarios, checkpoints may be taken infrequently. Also, a checkpoint can be created to provide duplication of the index, where a primary node creates a full index checkpoint to serialize the index, and other nodes can copy and deserialize the checkpoint to create their indexes.

The value of the threshold R can also be chosen based on resource constraints on the tenant in a multi-tenant environment. The amount of CPU and IO a tenant pays for in a serverless cloud deployment can dictate how frequently checkpoints can be taken because the tenant incurs the CPU and IO cost of checkpoint creation.

The value of the threshold R can further be chosen based on a rate of reads vs writes. For example, it is possible for some systems to have time periods that have heavy write activity (e.g., nightly batch ingests). However, there may not be a significant amount of reads during that time. Thus, checkpoints need not be created frequently since the penalty of an instance crash and restart is low due to a lack of similarity search activity. Also, in certain cases, there may be bulk snapshots taken and the checkpoint can be taken at the end of the bulk snapshot period. The policy of refreshing the HNSW index may already factor in these variables, but the checkpoint policy using the threshold R will typically be less aggressive than the policy of refreshing the HNSW index.

The value of the threshold R can be chosen based on a user-configurable parameter. A DBA may choose to tune this value based on a history of instance crashes, a database upgrade schedule, etc.

### Reload Algorithm

The HNSW index reload algorithm involves reloading the HNSW index, such as replaying the content into the in-memory index, after a restart from a shutdown. If checkpoints are available for a particular HNSW index, then the reload is faster if the checkpoints are used. Otherwise, the reload must create the HNSW index from scratch using the row ID to VID mapping that has been persisted into the row ID to VID mapping table. The HNSW index reload algorithm can be performed in the presence of full and incremental checkpoints.

The reload algorithm can include loading the vectors into their corresponding vertex ID slot in the in-memory index by querying the base table and the Row ID to VID mapping table as of the latest checkpoint SCN. These vectors and their assignments come from the base table and the Row ID to VID map. The reload algorithm can also include reading the checkpoint headers to decide the number of layers and other metadata for the HNSW index and allocating space for the HNSW index.

The reload algorithm can further include processing the incremental checkpoints in descending order of checkpoint SCNs, i.e., newer incremental checkpoints are processed before older incremental checkpoints. Alternatively, older incremental checkpoints can be processed before newer checkpoints, with some duplication of the same segments that were copied from older checkpoints also being copied from newer checkpoints. Then, the full checkpoint is processed.

The reload algorithm can additionally include processing the incremental checkpoints in descending order of SCNs by iterating through the layers stored in each checkpoint. In an embodiment, newer incremental checkpoints are processed before older incremental checkpoints and then the full checkpoint is processed. Iterating involves copying the neighborhood segments from the layer in the incremental checkpoint if the segment has not been overwritten by a newer checkpoint in the descending order process. For example, a bit can be checked to determine whether the segment was overwritten by a newer checkpoint and was already copied into memory from the newer checkpoint in the descending order process. Thus, the older checkpoint does not need to duplicate the segment. Iterating also involves copying out the layer-to-layer vertex ID segments in the incremental checkpoint if the segment has not been overwritten by a newer checkpoint in the descending order process. The deleted vectors are appended into the snapshot's deleted vector list.

Once all the checkpoints have been processed, all the index segments should have been reloaded. Then, the HNSW index is made available to queries and DMLs.

If the checkpoint SCN is lower than the latest build SCN that has been persisted in the global catalog table, then a new snapshot creation is invoked to catch the HNSW index up to the latest build SCN before shutting down the database. Otherwise, if there were many changes because the last checkpoint has not been created for a long time, that checkpoint may not be used if the SCN is too low, and a full index creation may be required from scratch because new vectors may not be available from the checkpoint.

### Cluster Duplication Using Checkpoints

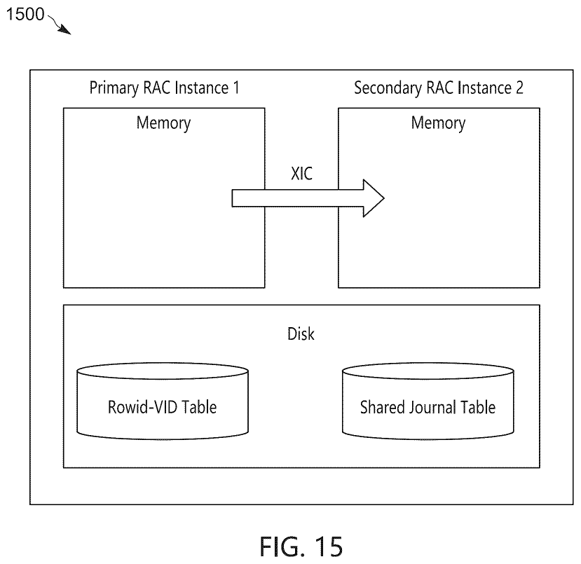

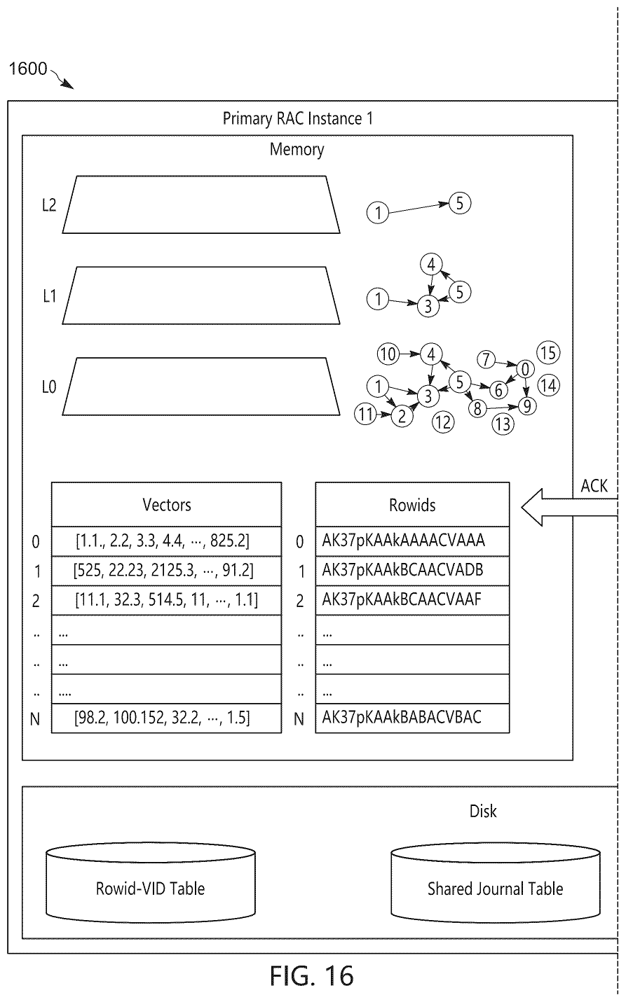

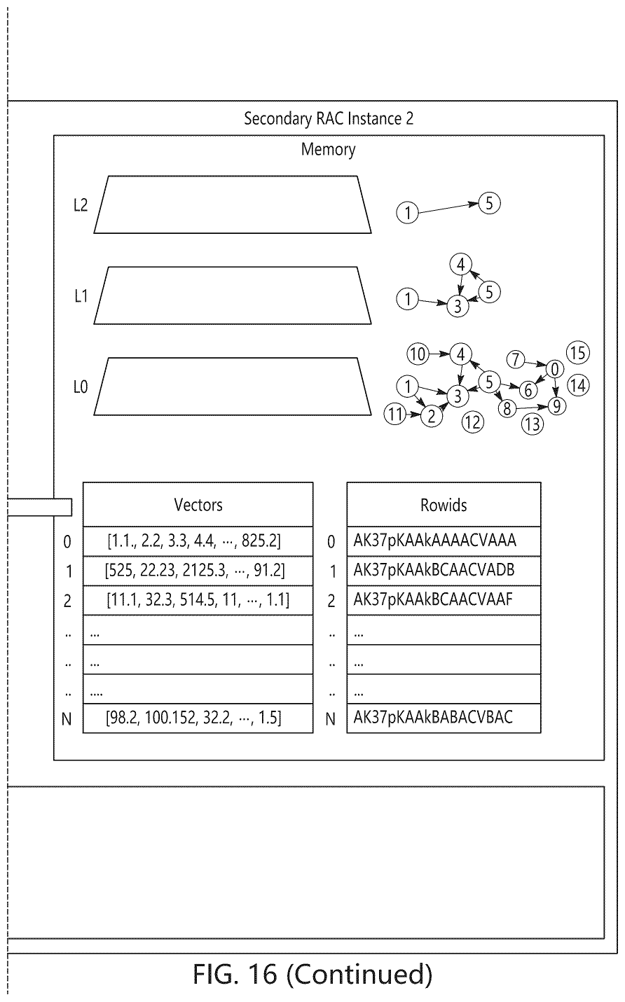

There are different ways of duplicating the HNSW index across all the nodes. FIGS. 15 and 16 are example illustrations 1500 and 1600 of index creation without using checkpoints according to an example embodiment. A master node, such as a primary RAC instance 1, performs a vertex ID assignment and populates the Row ID-VID mapping table. Then, the primary RAC instance 1 sends a broadcast, such as a cross-instance communication (XIC), to all nodes, such as secondary instances, to use the Row-ID VID mapping table to create their own HNSW indexes in parallel. At the end of the HNSW index creation, an HNSW checkpoint may be optionally triggered.

This approach does not use checkpoints for secondary instance index creation, which can lead to different indexes in different nodes. For example, vertex 4 may point to vertex 3 in layer 2 at the primary RAC instance 1 and may point to vertex 8 in layer 2 at the secondary RAC instance 2, as shown in the illustration 1600. This can result in different query results depending on which node the query lands on. The CPU utilization across all nodes can also be quite high because all nodes have to compute distances for neighborhood selection for a given vertex. Any instance that was not active as of the HNSW index creation can load the HNSW index using an available HNSW checkpoint through a background process. If a checkpoint is not available, a fresh load of the HNSW index can be done.

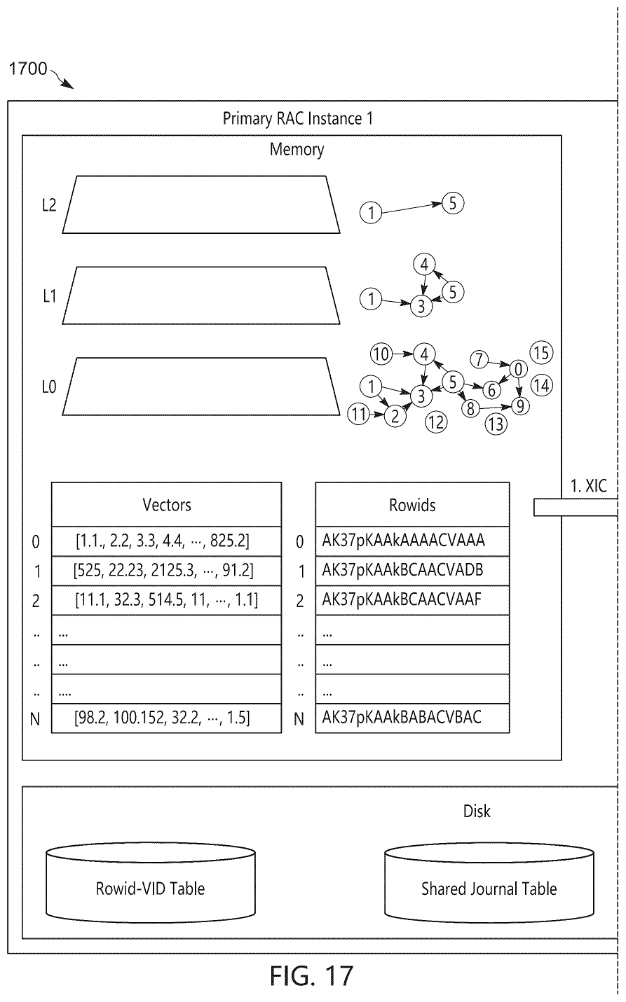

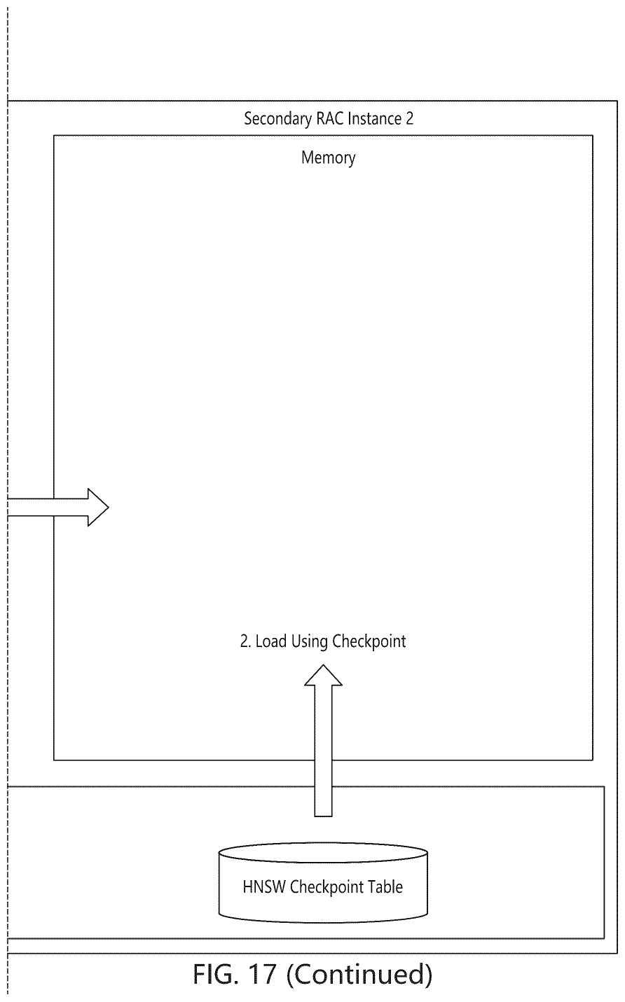

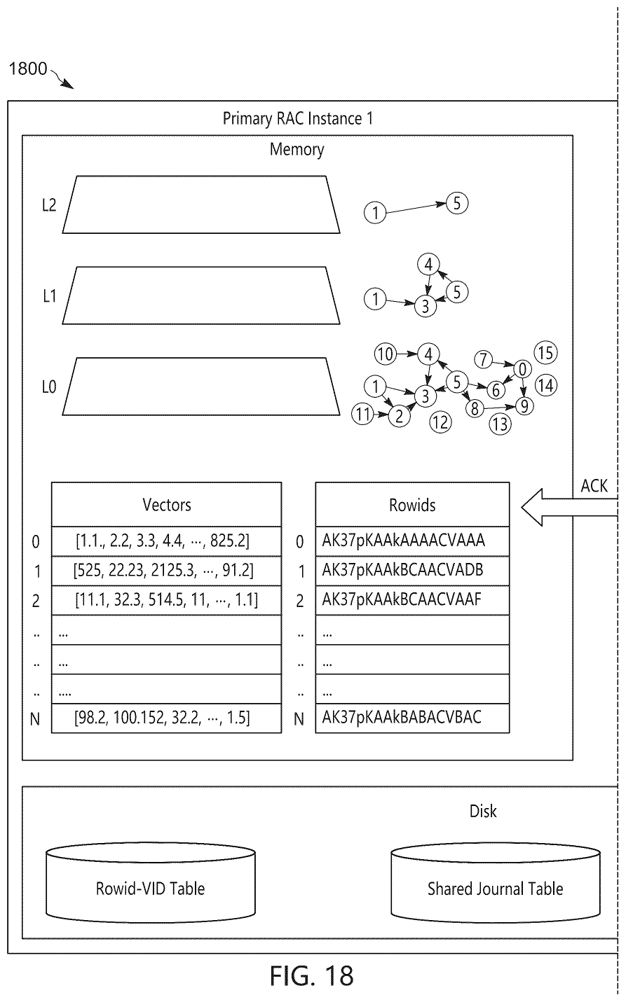

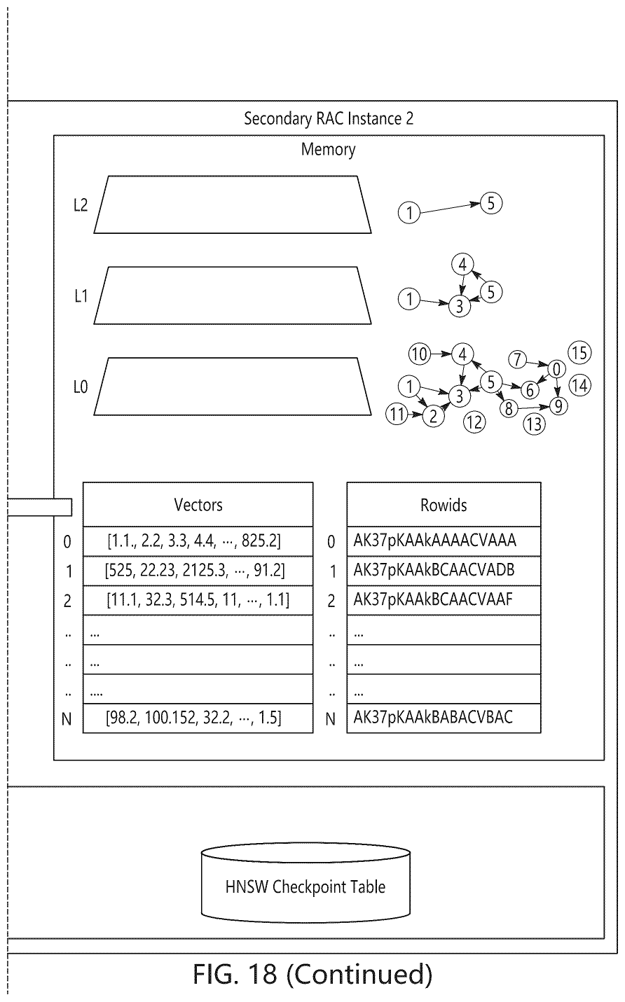

FIGS. 17 and 18 are example illustrations 1700 and 1800 of index creation using checkpoints according to an example embodiment. The master node, such as the primary RAC instance 1, does the vertex ID assignment and populates the Row ID-VID mapping table. Then, the master node creates the HNSW index, creates a full checkpoint of the index, and writes the full checkpoint to an HNSW checkpoint table. Then, the master node sends a broadcast to all nodes, such as secondary RAC instance 2, to load their HNSW indexes using the full checkpoint that the master node created.

This approach leads to all nodes having the same index and the same accuracy and query performance. The total time taken may be higher since all follower instances wait for the master to create its index and create a checkpoint before they start loading their index. However, this approach is more CPU efficient because only one node does the distance computation, and the other nodes inherit the neighborhoods for each vertex.

### Purging Checkpoints

Checkpoints can be purged based on several factors. One factor for checkpoint purging can be based on the staleness of checkpoints. When a new full checkpoint is taken/created, all checkpoints older than the new checkpoint are effectively superseded and can be purged. Significant transaction activity may have occurred since the latest incremental checkpoint, which means that a restore of the old copy of the HNSW index from the latest incremental checkpoint might not perform as well as desired. For example, the new transactions could have changed the data distribution significantly, and the number of new transactions may exceed a threshold number of transactions. To account for potential staleness, when the number of new transactions exceeds the threshold, the old checkpoint is purged, the HNSW is rebuilt from scratch, and a new checkpoint is created. Also, an excessive number of incremental checkpoints may have been created. For example, once the number of incremental checkpoints exceeds a threshold, the incremental checkpoints are compacted by generating a full checkpoint, and the incremental checkpoints that have been compacted are purged.

Another factor for checkpoint purging can be based on tablespace shrink, such as a user requirement. For example, the tablespace in which checkpoints are stored may need to be shrunk to satisfy a new lower quota requested by a user. Thus, memory space allocated for the checkpoints may shrink. In such cases, a DBA may decide to drop checkpoints to account for the smaller memory space.

Another factor for checkpoint purging can be based on an explicit DBA command. For example, Procedural Language/Structured Query Language (PL/SQL) packages can be provided for super users like DBAs to purge all or specific checkpoints.

### Example Methods

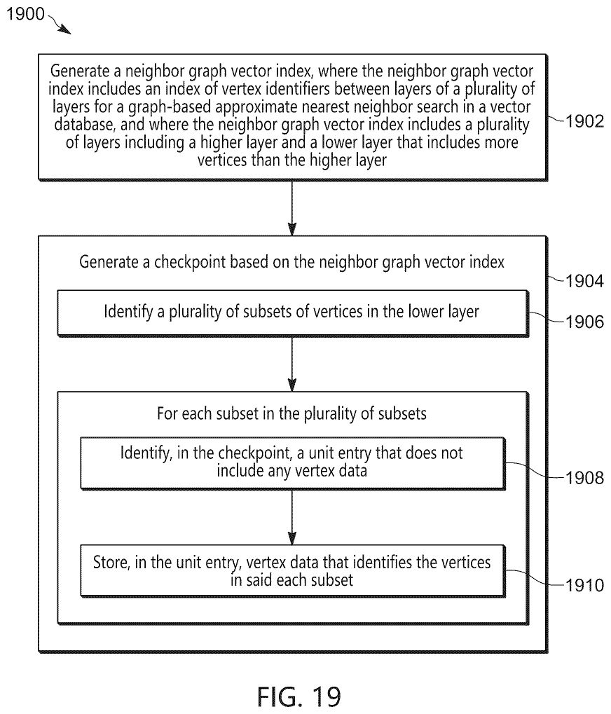

FIG. 19 is a flowchart 1900 of a method for checkpoint lower layer units for a neighbor graph vector index, such as an HNSW index, according to an example embodiment. The method is performed by one or more computing devices. At 1902, the method includes generating a neighbor graph vector index. The neighbor graph vector index includes an index of vertex identifiers between layers of a plurality of layers for a graph-based approximate nearest neighbor search in a vector database. The plurality of layers includes at least one higher layer, as well as at least one lower layer that includes more vertices than the at least one higher layer.

At 1904, the method includes generating a checkpoint based on the neighbor graph vector index. The checkpoint includes a plurality of unit entries, where a unit entry can be a layer unit. At 1906, generating includes identifying a plurality of subsets of vertices in the lower layer. At 1908, for each subset in the plurality of subsets, generating includes identifying, in the checkpoint, a unit entry that does not include any vertex data. At 1910, for each subset in the plurality of subsets, generating includes storing, in the unit entry, vertex data that identifies the vertices in that subset.

Storing can include storing the vertex data for a first unit entry concurrently with storing the vertex data for a second unit entry. For example, parallel processes can be used to generate portions of the neighbor graph vector index checkpoint concurrently for each unit entry.

According to a possible implementation, the checkpoint includes a plurality of vertex identifiers stored in series for each layer of the neighbor graph vector index. Each unit entry stores each subset of vertices of the lower layer as a separate series of vertex identifiers. Each unit entry can be a separate BLOB including vertex identifiers of the respective subset of vertices.

According to a possible implementation, the checkpoint includes a layer-to-layer map for each layer of the neighbor graph vector index. Each layer-to-layer map maps higher layer vertex identifiers to lower layer vertex identifiers. The checkpoint also includes a vertex neighbor map for each layer of the neighbor graph vector index. Each vertex neighbor map maps vertex identifiers of vertices in a respective layer to neighbor vertex identifiers of vertices that are neighbors of the vertices in the respective layer.

According to a possible implementation, the method includes shutting down a database instance that stores the neighbor graph vector index. The method also includes reloading the neighbor graph vector index from the checkpoint when the database instance restarts.

According to a possible implementation, the method includes reloading the neighbor graph vector index from the checkpoint by loading each of multiple unit entries in respective parallel processes. For example, parallel processes can be used to reload each unit entry concurrently with one or more other unit entries when reloading the neighbor graph vector index, such as when restoring the neighbor graph vector index.

According to a possible implementation, the method includes generating a catalog table, such as a global table, that tracks checkpoints for a plurality of different neighbor graph vector indexes. Fields of the catalog table indicate an identifier of a particular neighbor graph vector index of a particular checkpoint, an identifier of the particular checkpoint, an identifier of whether the checkpoint is an incremental checkpoint or a full checkpoint, and/or other information.

According to a possible implementation, the method includes generating an index table, such as a per-index table, that tracks checkpoints of a particular neighbor graph vector index. Fields of the index table indicate an identifier of a particular checkpoint, an identifier of a neighbor graph vector index layer, serialized data, an indicator of a type of information stored in the serialized data, and/or other information.

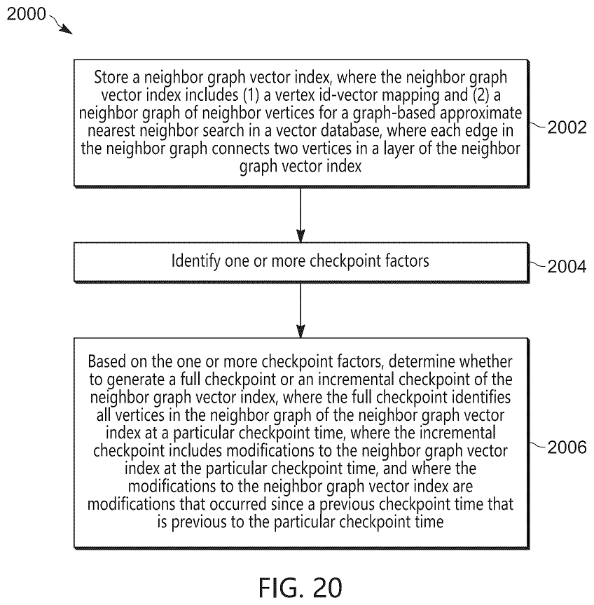

FIG. 20 is a flowchart 2000 of a method for checkpoint policies for a neighbor graph vector index, such as an HNSW index, according to an example embodiment. The method is performed by one or more computing devices. At 2002, the method includes storing a neighbor graph vector index. The neighbor graph vector index includes (1) a vertex ID-vector mapping. The vertex ID-vector mapping can be the vectors array 430 described above. The neighbor graph vector index also includes (2) a neighbor graph of neighbor vertices for a graph-based approximate nearest neighbor search in a vector database. The neighbor graph can be a neighbor array, 404, 414, and/or 424 described above for at least one of the layers L0, L1, L2, etc. Each edge in the neighbor graph connects two vertices in a layer of the neighbor graph vector index.

At 2004, the method includes identifying one or more checkpoint factors. The checkpoint factors can relate to initial generation of the neighbor graph vector index, full repopulation of the neighbor graph vector index, incremental population of a portion of the neighbor graph vector index, factors for a refresh threshold, and/or other factors.

At 2006, the method includes, based on the one or more checkpoint factors, determining whether to generate a full checkpoint or an incremental checkpoint of the neighbor graph vector index. The full checkpoint identifies all vertices in the neighbor graph of the neighbor graph vector index at a particular checkpoint time. For example, the full checkpoint includes all vertices that are currently indexed in the neighbor graph vector index as of a last checkpoint timestamp. Thus, the full checkpoint incorporates modifications to the neighbor graph vector index since a previous full checkpoint. The incremental checkpoint includes modifications to the neighbor graph vector index at the particular checkpoint time. The modifications to the neighbor graph vector index are modifications that occurred since a previous checkpoint time that is previous to the particular checkpoint time. The modifications to the neighbor graph vector index can be based on deletions, insertions, and/or changes to the vertices of the neighbor graph vector index.

According to a possible implementation, the method includes generating a full checkpoint in response to the initial generation of the neighbor graph vector index or full repopulation of the neighbor graph vector index. According to a possible example, the full checkpoint is generated by a primary database instance in response to the initial generation of the neighbor graph vector index by the primary database instance. The method can include loading the neighbor graph vector index at a secondary database instance using the full checkpoint in response to the initial generation of the neighbor graph vector index by the primary database instance. Thus, an HNSW index can be duplicated from a primary instance to a secondary instance using a full checkpoint.

According to a possible implementation, the method includes generating the incremental checkpoint in response to incrementally populating a portion of the neighbor graph vector index based on changes since a previous update of the neighbor graph vector index. According to a possible example, the method includes generating the full checkpoint in response to a number of incremental checkpoints since a previous full checkpoint exceeding a threshold.

According to a possible implementation, the method includes refreshing the neighbor graph vector index. Refreshing the neighbor graph vector index includes fully repopulating the neighbor graph vector index and/or incrementally populating a portion of the neighbor graph vector index based on changes since a previous update of the neighbor graph vector index. The method also includes ascertaining a number of times the neighbor graph vector index has been refreshed since a previous checkpoint. The method further includes generating a checkpoint based on the number of times exceeding a refresh threshold. The generated checkpoint is a full checkpoint or an incremental checkpoint. Thus, a checkpoint can be generated after a certain number of neighbor graph vector index refreshes. The refresh threshold can be based on at least one checkpoint factor, such as the availability of copies of the neighbor graph vector index, system resource constraints chosen by a user, a rate of reads to writes on the neighbor graph vector index, user configuration of the refresh threshold, and/or other checkpoint factors.

According to a possible implementation, the method includes generating the incremental checkpoint by copying, into the incremental checkpoint, segments of the neighbor graph vector index that have changed. Each segment includes at least one group of vertices and neighbors of each vertex in at least one group of vertices.

According to a possible implementation, the modifications to the neighbor graph vector index can include changes to a layer-to-layer map that maps higher layer vertex identifiers to lower layer vertex identifiers, where the higher layer is a layer above the lower layer in the neighbor graph vector index. The modifications to the neighbor graph vector index can also include changes to a vertex neighbor map that maps vertex identifiers of vertices in a particular layer to neighbor vertex identifiers of vertices that are neighbors of the vertices in the particular layer. The modifications to the neighbor graph vector index can further include vertex identifiers of vectors that have been deleted.

According to a possible implementation, the full checkpoint includes a layer-to-layer map of higher layer vertex identifiers to lower layer vertex identifiers, where the layer-to-layer map includes the lower layer vertex identifiers stored in a series in an order corresponding to the higher layer vertex identifiers. The full checkpoint also includes a neighbor map of vertex identifiers to neighbor vertex identifiers, where the neighbor vertex identifiers are stored in series in an order corresponding to the higher layer vertex identifiers. The full checkpoint also includes a deleted vector list comprising deleted vertex identifiers stored in series.

According to a possible implementation, the incremental checkpoint includes segment identifiers and a series of segments. Each segment identifier identifies a segment in the series of segments. Each segment is distinct from other segments in the series of segments. Each segment in the series of segments includes a contiguous set of vertices with a least one vertex that is different in the respective segment since the previous checkpoint time. The at least one different vertex in each segment can be different by being new, by having been changed since the previous checkpoint time, and/or by otherwise being different. A full or incremental checkpoint can include maps for all layers. Alternatively, a checkpoint can be generated for each layer.

According to a possible implementation, the method includes reloading the neighbor graph vector index from a plurality of incremental checkpoints by processing more recent incremental checkpoints before older incremental checkpoints. According to a possible implementation, the method includes purging checkpoints in response to generating a new full checkpoint, in response to a number of transactions on the neighbor graph vector index after a previous checkpoint exceeding a threshold, in response to a number of incremental checkpoints exceeding a threshold, in response to reduction of memory space allocated for the checkpoints, in response to a command to purge the checkpoints, and/or in response to other checkpoint purging factors.

### Dbms Overview

A database management system (DBMS) manages a database. A DBMS may comprise one or more database servers. A database comprises database data and a database dictionary that are stored on a persistent memory mechanism, such as a set of hard disks. Database data may be stored in one or more collections of records. The data within each record is organized into one or more attributes. In relational DBMSs, the collections are referred to as tables (or data frames), the records are referred to as records, and the attributes are referred to as attributes. In a document DBMS (“DOCS”), a collection of records is a collection of documents, each of which may be a data object marked up in a hierarchical-markup language, such as a JSON object or XML document. The attributes are referred to as JSON fields or XML elements. A relational DBMS may also store hierarchically-marked data objects; however, the hierarchically-marked data objects are contained in an attribute of record, such as JSON typed attribute.

Users interact with a database server of a DBMS by submitting to the database server commands that cause the database server to perform operations on data stored in a database. A user may be one or more applications running on a client computer that interacts with a database server. Multiple users may also be referred to herein collectively as a user.

A database command may be in the form of a database statement that conforms to a database language. A database language for expressing the database commands is the Structured Query Language (SQL). There are many different versions of SQL; some versions are standard and some proprietary, and there are a variety of extensions. Data definition language (“DDL”) commands are issued to a database server to create or configure data objects referred to herein as database objects, such as tables, views, or complex data types. SQL/XML is a common extension of SQL used when manipulating XML data in an object-relational database. Another database language for expressing database commands is Spark™ SQL, which uses a syntax based on function or method invocations.

In a DOCS, a database command may be in the form of functions or object method calls that invoke CRUD (Create Read Update Delete) operations. An example of an API for such functions and method calls is MQL (MondoDB™ Query Language). In a DOCS, database objects include a collection of documents, a document, a view, or fields defined by a JSON schema for a collection. A view may be created by invoking a function provided by the DBMS for creating views in a database.

Changes to a database in a DBMS are made using transaction processing. A database transaction is a set of operations that change database data. In a DBMS, a database transaction is initiated in response to a database command requesting a change, such as a DML command requesting an update, insert of a record, or a delete of a record or a CRUD object method invocation requesting to create, update or delete a document. DML commands and DDL specify changes to data, such as INSERT and UPDATE statements. A DML statement or command does not refer to a statement or command that merely queries database data. Committing a transaction refers to making the changes for a transaction permanent.

Under transaction processing, all the changes for a transaction are made atomically. When a transaction is committed, either all changes are committed, or the transaction is rolled back. These changes are recorded in change records, which may include redo records and undo records. Redo records may be used to reapply changes made to a data block. Undo records are used to reverse or undo changes made to a data block by a transaction.

An example of such transactional metadata includes change records that record changes made by transactions to database data. Another example of transactional metadata is embedded transactional metadata stored within the database data, the embedded transactional metadata describing transactions that changed the database data.

Undo records are used to provide transactional consistency by performing operations referred to herein as consistency operations. Each undo record is associated with a logical time. An example of logical time is a system change number (SCN). An SCN may be maintained using a Lamporting mechanism, for example. For data blocks that are read to compute a database command, a DBMS applies the needed undo records to copies of the data blocks to bring the copies to a state consistent with the snapshot time of the query. The DBMS determines which undo records to apply to a data block based on the respective logical times associated with the undo records.

When operations are referred to herein as being performed at commit time or as being commit time operations, the operations are performed in response to a request to commit a database transaction. DML commands may be auto-committed, that is, are committed in a database session without receiving another command that explicitly requests to begin and/or commit a database transaction. For DML commands that are auto-committed, the request to execute the DML command is also a request to commit the changes made for the DML command.

In a distributed transaction, multiple DBMSs commit a distributed transaction using a two-phase commit approach. Each DBMS executes a local transaction in a branch transaction of the distributed transaction. One DBMS, the coordinating DBMS, is responsible for coordinating the commitment of the transaction on one or more other database systems. The other DBMSs are referred to herein as participating DBMSs.

A two-phase commit involves two phases, the prepare-to-commit phase, and the commit phase. In the prepare-to-commit phase, branch transaction is prepared in each of the participating database systems. When a branch transaction is prepared on a DBMS, the database is in a “prepared state” such that it can guarantee that modifications executed as part of a branch transaction to the database data can be committed. This guarantee may entail storing change records for the branch transaction persistently. A participating DBMS acknowledges when it has completed the prepare-to-commit phase and has entered a prepared state for the respective branch transaction of the participating DBMS.

In the commit phase, the coordinating database system commits the transaction on the coordinating database system and on the participating database systems. Specifically, the coordinating database system sends messages to the participants requesting that the participants commit the modifications specified by the transaction to data on the participating database systems. The participating database systems and the coordinating database system then commit the transaction.

On the other hand, if a participating database system is unable to prepare or the coordinating database system is unable to commit, then at least one of the database systems is unable to make the changes specified by the transaction. In this case, all of the modifications at each of the participants and the coordinating database system are retracted, restoring each database system to its state prior to the changes.

A client may issue a series of requests, such as requests for execution of queries, to a DBMS by establishing a database session. A database session comprises a particular connection established for a client to a database server through which the client may issue a series of requests. A database session process executes within a database session and processes requests issued by the client through the database session. The database session may generate an execution plan for a query issued by the database session client and marshal slave processes for execution of the execution plan.

The database server may maintain session state data about a database session. The session state data reflects the current state of the session and may contain the identity of the user for which the session is established, services used by the user, instances of object types, language and character set data, statistics about resource usage for the session, temporary variable values generated by processes executing software within the session, storage for cursors, variables and other information.

A database server includes multiple database processes. Database processes run under the control of the database server (i.e. can be created or terminated by the database server) and perform various database server functions. Database processes include processes running within a database session established for a client.

A database process is a unit of execution. A database process can be a computer system process or thread or a user-defined execution context such as a user thread or fiber. Database processes may also include “database server system” processes that provide services and/or perform functions on behalf of the entire database server. Such database server system processes include listeners, garbage collectors, log writers, and recovery processes.

A multi-node database management system is made up of interconnected computing nodes (“nodes”), each running a database server that shares access to the same database. Typically, the nodes are interconnected via a network and share access, in varying degrees, to shared storage, e.g. shared access to a set of disk drives and data blocks stored thereon. The nodes in a multi-node database system may be in the form of a group of computers (e.g. work stations, personal computers) that are interconnected via a network. Alternately, the nodes may be the nodes of a grid, which is composed of nodes in the form of server blades interconnected with other server blades on a rack.

Each node in a multi-node database system hosts a database server. A server, such as a database server, is a combination of integrated software components and an allocation of computational resources, such as memory, a node, and processes on the node for executing the integrated software components on a processor, the combination of the software and computational resources being dedicated to performing a particular function on behalf of one or more clients.

Resources from multiple nodes in a multi-node database system can be allocated to running a particular database server's software. Each combination of the software and allocation of resources from a node is a server that is referred to herein as a “server instance” or “instance”. A database server may comprise multiple database instances, some or all of which are running on separate computers, including separate server blades.

A database dictionary may comprise multiple data structures that store database metadata. A database dictionary may, for example, comprise multiple files and tables. Portions of the data structures may be cached in main memory of a database server.

When a database object is said to be defined by a database dictionary, the database dictionary contains metadata that defines properties of the database object. For example, metadata in a database dictionary defining a database table may specify the attribute names and data types of the attributes, and one or more files or portions thereof that store data for the table. Metadata in the database dictionary defining a procedure may specify a name of the procedure, the procedure's arguments and the return data type, and the data types of the arguments, and may include source code and a compiled version thereof.

A database object may be defined by the database dictionary, but the metadata in the database dictionary itself may only partly specify the properties of the database object. Other properties may be defined by data structures that may not be considered part of the database dictionary. For example, a user-defined function implemented in a JAVA class may be defined in part by the database dictionary by specifying the name of the user-defined function and by specifying a reference to a file containing the source code of the Java class (i.e. .java file) and the compiled version of the class (i.e. .class file).

Native data types are data types supported by a DBMS “out-of-the-box”. Non-native data types, on the other hand, may not be supported by a DBMS out-of-the-box. Non-native data types include user-defined abstract types or object classes. Non-native data types are only recognized and processed in database commands by a DBMS once the non-native data types are defined in the database dictionary of the DBMS, by, for example, issuing DDL statements to the DBMS that define the non-native data types. Native data types do not have to be defined by a database dictionary to be recognized as a valid data types and to be processed by a DBMS in database statements. In general, database software of a DBMS is programmed to recognize and process native data types without configuring the DBMS to do so by, for example, defining a data type by issuing DDL statements to the DBMS.

### Hardware Overview

According to one embodiment, the techniques described herein are implemented by one or more special-purpose computing devices. The special-purpose computing devices may be hard-wired to perform the techniques or may include digital electronic devices such as one or more application-specific integrated circuits (ASICs) or field programmable gate arrays (FPGAs) that are persistently programmed to perform the techniques or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

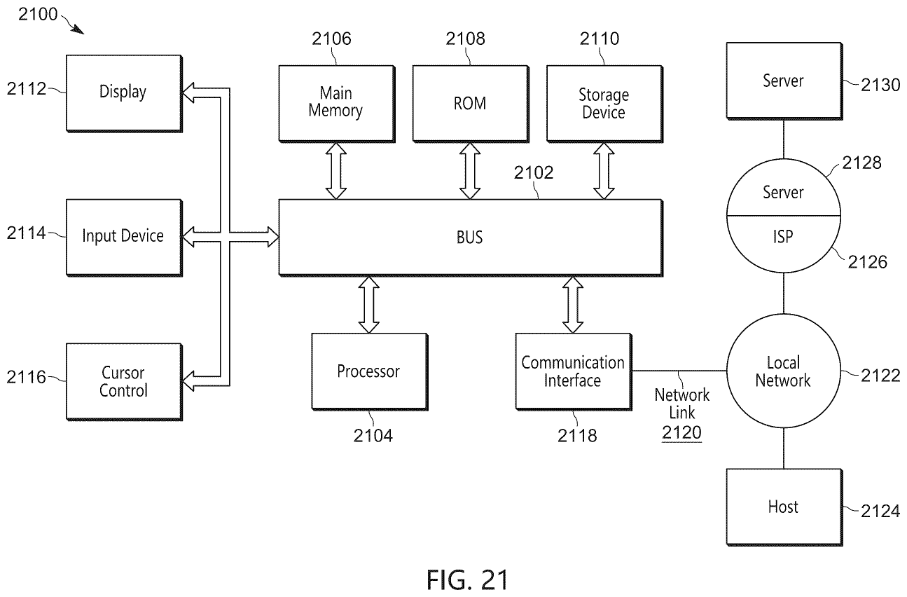

For example, FIG. 21 is a block diagram that illustrates a computer system 2100 upon which aspects of the illustrative embodiments may be implemented. Computer system 2100 includes a bus 2102 or other communication mechanism for communicating information, and a hardware processor 2104 coupled with bus 2102 for processing information. Hardware processor 2104 may be, for example, a general-purpose microprocessor.

Computer system 2100 also includes a main memory 2106, such as a random-access memory (RAM) or other dynamic storage device, coupled to bus 2102 for storing information and instructions to be executed by processor 2104. Main memory 2106 also may be used for storing temporary variables or other intermediate information during execution of instructions to be executed by processor 2104. Such instructions, when stored in non-transitory storage media accessible to processor 2104, render computer system 2100 into a special-purpose machine that is customized to perform the operations specified in the instructions.

Computer system 2100 further includes a read only memory (ROM) 2108 or other static storage device coupled to bus 2102 for storing static information and instructions for processor 2104. A storage device 2110, such as a magnetic disk, optical disk, or solid-state drive is provided and coupled to bus 2102 for storing information and instructions.

Computer system 2100 may be coupled via bus 2102 to a display 2112 for displaying information to a computer user. An input device 2114, including alphanumeric and other keys, is coupled to bus 2102 for communicating information and command selections to processor 2104. Another type of user input device is cursor control 2116, such as a mouse, a trackball, a touch screen, a track pad, and/or cursor direction keys for communicating direction information and command selections to processor 2104 and for controlling cursor movement on display 2112. This input device typically has two degrees of freedom in two axes, a first axis (e.g., x) and a second axis (e.g., y), that allows the device to specify positions in a plane.

Computer system 2100 may implement the techniques described herein using customized hard-wired logic, one or more ASICs or FPGAs, firmware and/or program logic which in combination with the computer system causes or programs computer system 2100 to be a special-purpose machine. According to one embodiment, the techniques herein are performed by computer system 2100 in response to processor 2104 executing one or more sequences of one or more instructions contained in main memory 2106. Such instructions may be read into main memory 2106 from another storage medium, such as storage device 2110. Execution of the sequences of instructions contained in main memory 2106 causes processor 2104 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 2110. Volatile media includes dynamic memory, such as main memory 2106. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and/or any other storage media.

Storage media is distinct from but may be used in conjunction with transmission media. Transmission media participates in transferring information between storage media. For example, transmission media includes coaxial cables, copper wire and fiber optics, including the wires that comprise bus 2102. Transmission media can also take the form of acoustic or light waves, such as those generated during radio-wave and infra-red data communications.

Various forms of media may be involved in carrying one or more sequences of one or more instructions to processor 2104 for execution. For example, the instructions may initially be carried on a magnetic disk or solid-state drive of a remote computer. The remote computer can load the instructions into its dynamic memory and send the instructions over a telephone line using a modem or send the instructions using a network. A receiver, such as a modem, local to computer system 2100 can receive the data and use, for an example, an infra-red transmitter to convert the data to an infra-red signal. An infra-red detector can receive the data carried in the infra-red signal and appropriate circuitry can place the data on bus 2102. Bus 2102 carries the data to main memory 2106, from which processor 2104 retrieves and executes the instructions. The instructions received by main memory 2106 may optionally be stored on storage device 2110 either before or after execution by processor 2104.

Computer system 2100 also includes a communication interface 2118 coupled to bus 2102. Communication interface 2118 provides a two-way data communication coupling to a network link 2120 that is connected to a local network 2122. For example, communication interface 2118 may be an integrated services digital network (ISDN) card, cable modem, satellite modem, or a modem to provide a data communication connection to a corresponding type of telephone line. As another example, communication interface 2118 may be a local area network (LAN) card to provide a data communication connection to a compatible LAN. Wireless links may also be implemented, such as to a wireless local area network (WLAN) or to a cellular network. In any such implementation, communication interface 2118 sends and receives electrical, electromagnetic, radio, optical, and/or other signals that carry digital data streams representing various types of information.

Network link 2120 typically provides data communication through one or more networks to other data devices. For example, network link 2120 may provide a connection through local network 2122 to a host computer 2124 or to data equipment operated by an Internet Service Provider (ISP) 2126. ISP 2126 in turn provides data communication services through the world-wide packet data communication network now commonly referred to as the “Internet” 2128. Local network 2122 and Internet 2128 both use electrical, electromagnetic, or optical signals that carry digital data streams. The signals through the various networks and the signals on network link 2120 and through communication interface 2118, which carry the digital data to and from computer system 2100, are example forms of transmission media.

Computer system 2100 can send messages and receive data, including program code, through the network(s), network link 2120 and communication interface 2118. In the Internet example, a server 2130 might transmit a requested code for an application program through Internet 2128, ISP 2126, local network 2122 and communication interface 2118.

The received code may be executed by processor 2104 as it is received, and/or stored in storage device 2110, or other non-volatile storage for later execution.

### Software Overview

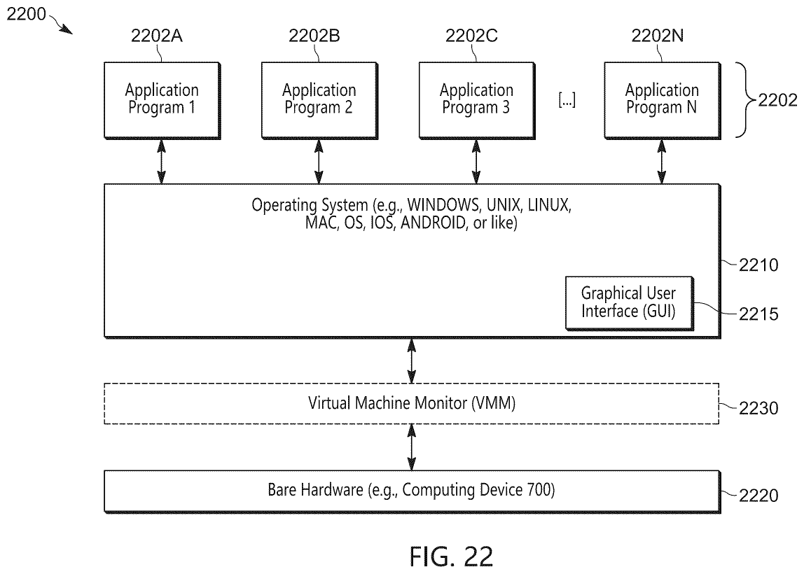

FIG. 22 is a block diagram of a basic software system 2200 that may be employed for controlling the operation of computer system 2100. Software system 2200 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 2200 is provided for directing the operation of computer system 2100. Software system 2200, which may be stored in system memory (RAM) 2106 and on fixed storage (e.g., hard disk or flash memory) 2110, includes a kernel or operating system (OS) 2210.

The OS 2210 manages low-level aspects of computer operation, including managing execution of processes, memory allocation, file input and output (I/O), and device I/O. One or more application programs, represented as 2202A, 2202B, 2202C . . . 2202N, may be “loaded” (e.g., transferred from fixed storage 2110 into memory 2106) for execution by the system 2200. The applications or other software intended for use on computer system 2100 may also be stored as a set of downloadable computer-executable instructions, for example, for downloading and installation from an Internet location (e.g., a Web server, an app store, or other online service).

Software system 2200 includes a graphical user interface (GUI) 2215, for receiving user commands and data in a graphical (e.g., “point-and-click” or “touch gesture”) fashion. These inputs, in turn, may be acted upon by the system 2200 in accordance with instructions from operating system 2210 and/or application(s) 2202. The GUI 2215 also serves to display the results of operation from the OS 2210 and application(s) 2202, whereupon the user may supply additional inputs or terminate the session (e.g., log off).

OS 2210 can execute directly on the bare hardware 2220 (e.g., processor(s) 2104) of computer system 2100. Alternatively, a hypervisor or virtual machine monitor (VMM) 2230 may be interposed between the bare hardware 2220 and the OS 2210. In this configuration, VMM 2230 acts as a software “cushion” or virtualization layer between the OS 2210 and the bare hardware 2220 of the computer system 2100.

VMM 2230 instantiates and runs one or more virtual machine instances (“guest machines”). Each guest machine comprises a “guest” operating system, such as OS 2210, and one or more applications, such as application(s) 2202, designed to execute on the guest operating system. The VMM 2230 presents the guest operating systems with a virtual operating platform and manages the execution of the guest operating systems.

In some instances, the VMM 2230 may allow a guest operating system to run as if it is running on the bare hardware 2220 of computer system 2100 directly. In these instances, the same version of the guest operating system configured to execute on the bare hardware 2220 directly may also execute on VMM 2230 without modification or reconfiguration. In other words, VMM 2230 may provide full hardware and CPU virtualization to a guest operating system in some instances.

In other instances, a guest operating system may be specially designed or configured to execute on VMM 2230 for efficiency. In these instances, the guest operating system is “aware” that it executes on a virtual machine monitor. In other words, VMM 2230 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g., content of registers) between allotments of the hardware processor time when the computer system process is not running. Computer system processes run under the control of an operating system and may run under the control of other programs being executed on the computer system.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprises two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure, applications, and servers, including one or more database servers.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
storing a neighbor graph vector index, wherein the neighbor graph vector index comprises (1) a vertex ID-vector mapping and (2) a neighbor graph of neighbor vertices for a graph-based approximate nearest neighbor search in a vector database, where each edge in the neighbor graph connects two vertices in a layer of the neighbor graph vector index;
identifying one or more checkpoint factors; and
based on the one or more checkpoint factors, determining whether to generate a full checkpoint or an incremental checkpoint of the neighbor graph vector index,
wherein the full checkpoint identifies all vertices in the neighbor graph of the neighbor graph vector index at a particular checkpoint time,
wherein the incremental checkpoint includes modifications to the neighbor graph vector index at the particular checkpoint time, and
wherein the modifications to the neighbor graph vector index are modifications that occurred since a previous checkpoint time that is previous to the particular checkpoint time,
wherein the method is performed by one or more computing devices.

2. The method of claim 1, further comprising generating the full checkpoint in response to:
initial generation of the neighbor graph vector index, or
full repopulation of the neighbor graph vector index.

3. The method of claim 2,
wherein the full checkpoint is generated by a primary database instance in response to initial generation of the neighbor graph vector index by the primary database instance, and
wherein the method further comprises loading the neighbor graph vector index at a secondary database instance using the full checkpoint in response to initial generation of the neighbor graph vector index by the primary database instance.

4. The method of claim 1, further comprising generating the incremental checkpoint in response to incrementally populating a portion of the neighbor graph vector index based on changes since a previous update of the neighbor graph vector index.

5. The method of claim 4, further comprising generating the full checkpoint in response to a number of incremental checkpoints since a previous full checkpoint exceeding a threshold.

6. The method of claim 1, further comprising:
refreshing the neighbor graph vector index, where refreshing comprises at least one selected from:
fully repopulating the neighbor graph vector index, or
incrementally populating a portion of the neighbor graph vector index based on changes since a previous update of the neighbor graph vector index,
ascertaining a number of times the neighbor graph vector index has been refreshed since a previous checkpoint; and
generating a checkpoint based on the number of times exceeding a refresh threshold, where the generated checkpoint comprises the full checkpoint or the incremental checkpoint.

7. The method of claim 6, wherein the refresh threshold is based on at least one checkpoint factor selected from:
availability of copies of the neighbor graph vector index,
system resource constraints chosen by a user,
a rate of reads to writes on the neighbor graph vector index, or
user configuration of the refresh threshold.

8. The method of claim 1, further comprising generating the incremental checkpoint by copying, into the incremental checkpoint, segments of the neighbor graph vector index that have changed, where each segment comprises a group of vertices and neighbors of each vertex in the group of vertices.

9. The method of claim 1, wherein the modifications to the neighbor graph vector index comprises:
changes to a layer-to-layer map that maps higher layer vertex identifiers to lower layer vertex identifiers, where the higher layer is a layer above the lower layer in the neighbor graph vector index,
changes to a vertex neighbor map that maps vertex identifiers of vertices in a particular layer to neighbor vertex identifiers of vertices that are neighbors of the vertices in the particular layer, or
vertex identifiers of vectors that have been deleted.

10. The method of claim 1, wherein the full checkpoint comprises
a layer-to-layer map of higher layer vertex identifiers to lower layer vertex identifiers, wherein the layer-to-layer map comprises the lower layer vertex identifiers stored in a series in an order corresponding to the higher layer vertex identifiers;
a neighbor map of vertex identifiers to neighbor vertex identifiers, wherein the neighbor vertex identifiers are stored in series in an order corresponding to the higher layer vertex identifiers; and
a deleted vector list comprising deleted vertex identifiers stored in series.

11. The method of claim 1,
wherein the incremental checkpoint comprises segment identifiers and a series of segments,
wherein each segment identifier identifies a segment in the series of segments, and
wherein each segment in the series of segments comprises a contiguous set of vertices with a least one vertex that is different in the respective segment since the previous checkpoint time, where each segment is distinct from other segments in the series of segments.

12. The method of claim 1, further comprising reloading the neighbor graph vector index from a plurality of incremental checkpoints by processing more recent incremental checkpoints before older incremental checkpoints.

13. The method of claim 1, further comprising purging checkpoints in response to at least one selected from
generating a new full checkpoint,
a number of transactions on the neighbor graph vector index after a previous checkpoint exceeding a threshold,
a number of incremental checkpoints exceeding a threshold,
reduction of memory space allocated for the checkpoints, and
a command to purge the checkpoints.

14. One or more non-transitory storage media storing one or more sequences of instructions which, when executed by one or more computing devices, cause:
storing a neighbor graph vector index, wherein the neighbor graph vector index comprises (1) a vertex ID-vector mapping and (2) a neighbor graph of neighbor vertices for a graph-based approximate nearest neighbor search in a vector database, where each edge in the neighbor graph connects two vertices in a layer of the neighbor graph vector index;
identifying one or more checkpoint factors; and
based on the one or more checkpoint factors, determining whether to generate a full checkpoint or an incremental checkpoint of the neighbor graph vector index,
wherein the full checkpoint identifies all vertices in the neighbor graph of the neighbor graph vector index at a particular checkpoint time,
wherein the incremental checkpoint includes modifications to the neighbor graph vector index at the particular checkpoint time, and
wherein the modifications to the neighbor graph vector index are modifications that occurred since a previous checkpoint time that is previous to the particular checkpoint time,
wherein the method is performed by one or more computing devices.

15. The one or more non-transitory storage media of claim 14, wherein the instructions include instructions for generating the full checkpoint in response to:
initial generation of the neighbor graph vector index, or
full repopulation of the neighbor graph vector index.

16. The one or more non-transitory storage media of claim 15,
wherein the full checkpoint is generated by a primary database instance in response to initial generation of the neighbor graph vector index by the primary database instance, and
wherein the instructions include instructions for loading the neighbor graph vector index at a secondary database instance using the full checkpoint in response to initial generation of the neighbor graph vector index by the primary database instance.

17. The one or more non-transitory storage media of claim 14, wherein the instructions include instructions for generating the incremental checkpoint in response to incrementally populating a portion of the neighbor graph vector index based on changes since a previous update of the neighbor graph vector index.

18. The one or more non-transitory storage media of claim 17, wherein the instructions include instructions for generating the full checkpoint in response to a number of incremental checkpoints since a previous full checkpoint exceeding a threshold.

19. The one or more non-transitory storage media of claim 14, wherein the instructions include instructions for
refreshing the neighbor graph vector index, where refreshing comprises at least one selected from:
fully repopulating the neighbor graph vector index, or
incrementally populating a portion of the neighbor graph vector index based on changes since a previous update of the neighbor graph vector index,
ascertaining a number of times the neighbor graph vector index has been refreshed since a previous checkpoint; and
generating a checkpoint based on the number of times exceeding a refresh threshold, where the generated checkpoint comprises the full checkpoint or the incremental checkpoint.

20. The one or more non-transitory storage media of claim 19, wherein the refresh threshold is based on at least one checkpoint factor selected from:
availability of copies of the neighbor graph vector index,
system resource constraints chosen by a user,
a rate of reads to writes on the neighbor graph vector index, or
user configuration of the refresh threshold.
